(19) United States
(12) Patent Application Publication
(10) Pub. No.: US 2017/0308157 A1
(43) Pub. Date: Oct. 26, 2017

(54) HEAD-MOUNTED DISPLAY DEVICE, DISPLAY SYSTEM, CONTROL METHOD FOR HEAD-MOUNTED DISPLAY DEVICE, AND COMPUTER PROGRAM

(71) Applicant: SEIKO EPSON CORPORATION, Tokyo (JP)

(72) Inventors: Atsunari TSUDA, Suwa-shi (JP); Masahide TAKANO, Matusmoto-shi (JP)

(73) Assignee: SEIKO EPSON CORPORATION, Tokyo (JP)

(21) Appl. No.: 15/488,109

(22) Filed: Apr. 14, 2017

(30) Foreign Application Priority Data
Apr. 25, 2016 (JP) 2016-087032
Dec. 13, 2016 (JP) 2016-241270

(51) Int. Cl. G06F 3/01; H04W 4/00; G02B 27/01; G06T 19/00

(52) U.S. Cl. CPC G06F 3/012; G02B 27/0179; H04W 4/008; G02B 27/017; G02B 2027/014; G02B 2027/0138; G02B 2027/0134; G02B 2027/0178; G02B 2027/0187; G06T 19/006; G02B 2027/0141

(57) ABSTRACT

A head-mounted display device including an image display section attached to a head includes a specific-direction detecting section configured to detect a specific direction decided according to a direction of the image display section, a wireless communication section, and a processing section configured to perform presentation of information to an external information processing device via the wireless communication section. The processing section specifies a predetermined range including the specific direction detected by the specific-direction detecting section, performs communication with a short-range wireless communication terminal present in the specified predetermined range via the wireless communication section, receives data from the short-range wireless communication terminal, and transmits presentation information based on the received data to the information processing device.

### BACKGROUND

### 1. Technical Field

The present invention relates to a head-mounted display device, a display system, a control method for the head-mounted display device, and a computer program,

### 2. Related Art

JP-T-2008-539493 (Patent Literature 1) describes a system that provides an individual shopper with a personal purchasing device in a shopping venue to support an individual purchasing activity of the shopper and provides the shopper with information using a consumer interface.

However, in the technique described in Patent Literature 1, although the shopper can receive support in the shopping venue, the shopper cannot receive support in a place away from the shopping venue. When the shopper is away from the shopping venue, the shopper cannot purchase commodities in a sense of actually performing shopping in the shopping venue. In this way, under the current situation, means for enabling the shopper to receive support of purchasing in a place away from the shopping venue has not been sufficiently contrived. Note that such a problem is not limited to the support of shopping and also occurs When a shopper desires to make some request from the outside of a facility taking into account a situation in the facility.

JP-A-2011-217098 and JP-A-2014-215748 are examples of related art.

### SUMMARY

An advantage of some aspects of the invention is to solve at least a part of the problems described above, and the invention can be implemented as the following forms.

(1) According to a first aspect of the invention, a head-mounted display device including an image display section attached to a head is provided. The head-mounted display device includes: a specific-direction detecting section configured to detect a specific direction decided according to a direction of the image display section; a wireless communication section; and a processing section configured to perform presentation of information to an external information processing device via the wireless communication section. The processing section specifies a predetermined range including the specific direction detected by the specific-direction detecting section, performs communication with a short-range wireless communication terminal present in the specified predetermined range via the wireless communication section, receives data from the short-range wireless communication terminal, and transmits presentation information based on the received data to the information processing device. With the head-mounted display device according to this aspect, it is possible to transmit, to the information processing device, the presentation information based on the data received from the short-range wireless communication terminal present in the predetermined range including the specific direction decided according to the direction of the image display section. Therefore, an operator of the information processing device can receive, while staying in a position away from a user wearing the head-mounted display device, information it the periphery of the specific direction decided according to the direction of the image display section. Therefore, with the head-mounted display device according to this aspect, it is possible to appropriately and efficiently present information in the specific direction decided according to the direction of the image display section to the operator of the information processing device present in the position away from the user.

(2) In the head-mounted display device according to the aspect, the specific direction may be a direction that the user is viewing. With the head-mounted display device according to this aspect, it is possible to appropriately and efficiently present information in a line-of-sight direction of the user to the operator of the information processing device present in the position away from the user.

(3) In the head-mounted display device according to the aspect, the head-mounted display device may further include a camera configured to pick up an image in the direction that the user is viewing. The processing section may transmit at least a part of the image picked up by the camera to the information processing device via the wireless communication section as a picked-up image for transmission. With the head-mounted display device according to this aspect, it is possible to present an outside scene viewed by the user using the image picked up by the camera. Therefore, with the head-mounted display device according to this aspect, it is possible to more appropriately and efficiently present information to the operator of the information processing device.

(4) In the head-mounted display device according to the aspect, the processing section may specify a portion overlapping the predetermined range in the picked-up image for transmission and perform image processing concerning the overlapping portion. With the head-mounted display device according to this aspect, it is possible to clearly indicate the predetermined range to the operator of the information processing device present in the position away from the user.

(5) In the head-mounted display device according to the aspect, the data received from the short-range wireless communication terminal present in the predetermined range may be data for each of types of commodities. With the head-mounted display device according to this aspect, is possible to receive the data for each of the types of the commodities from the short-range wireless communication terminal disposed for each of the types of the commodities. Consequently, it is possible to present information for each of the types of the commodities to the external information processing device. Therefore, with the head-mounted display device according to this aspect, it is possible to support purchase of the commodities by the operator of the information processing device.

(6) In the head-mounted display device according to the aspect, the processing section may receive, from the external information processing device, an order instruction for a commodity selected out of the commodities, the information of which is presented. With the head-mounted display device according to this aspect, the operator of the information processing device present in the position away from the user can order the commodity from the position away from the user.

(7) In the head-mounted display device according to the aspect, the processing section may transmit start information for performing settlement processing to the external information processing device and may receive, from the external information processing device, the order instruction together with a notification to the effect that the settlement is completed. With the head-mounted display device according to this aspect, the operator of the information processing device present in the position away from the user can also perform settlement of purchase of the commodities from the position away from the user.

(8) In the head-mounted display device according to the aspect, the external information processing device may be another head-mounted display device different from the head-mounted display device. With the head-mounted display device according to this aspect, it is possible to provide an environment of use same as an environment of use by the user to a user wearing the other head-mounted display device.

(9) According to a second aspect of the invention, a display system including: a head-mounted display device including an image display section attached to a head; and an information processing device is provided. The head-mounted display device of the display system includes: a specific-direction detecting section configured to detect a specific direction decided according to a direction of the image display section; a wireless communication section; and a processing section configured to perform presentation of information to the information processing device via the wireless communication section. The processing section specifies a predetermined range including the specific direction detected by the specific-direction detecting section, performs communication with a short-range wireless communication terminal present in the specified predetermined range via the wireless communication section, receives data from the short-range wireless communication terminal, and transmits presentation information based on the received data to the information processing device. The information processing device of the display system receives the presentation information transmitted from the head-mounted display device and performs display on the basis of the received presentation information. With the display system according to this aspect, it is possible to transmit, to the information processing device, the presentation information based on the data received from the short-range wireless communication terminal present in the predetermined range including a line-of-sight direction of a user wearing the head-mounted display device. Therefore, an operator of the information processing device can receive, while staying in a position away from the user wearing the head-mounted ay device, information in the periphery of the specific direction decided according to the direction of the image display section. Therefore, the display system according to this aspect can appropriately and efficiently present information in the specific direction decided according to the direction of the image display section to the operator of the information processing device present in the position away from the user.

The invention can also be implemented in various forms other than the head-mounted display device. The invention can be implemented as, for example, a control method for the head-mounted display device, a computer program for realizing functions of the components included in the head-mounted display device, and a recording medium having the computer program recorded therein.

### BRIEF DESCRIPTION OF THE DRAWINGS

The invention will be described with reference to the accompanying drawings, wherein like numbers reference like elements.

FIG. 1 is an explanatory diagram showing a schematic configuration of a display system in a first embodiment of the invention.

FIG. 2 is a main part plan view showing the configuration of an optical system included in an image display section.

FIG. 3 is a diagram showing a main part configuration of the image display section viewed from a user.

FIG. 4 is a diagram for explaining an angle of view of a camera.

FIG. 5 is a block diagram functionally showing the configuration of an HMD.

FIG. 6 is a block diagram functionally showing the configuration of a control device.

FIG. 7 is an explanatory diagram showing an example of augmented reality display by the HMD.

FIG. 8 is a block, diagram functionally showing the configuration of a control device of a supported person HMD.

FIG. 9 is an explanatory diagram showing an example of augmented reality display by the supported person HMD.

FIG. 10 is an explanatory diagram showing processes executed on the supported person HMD side and a supporter HMD side when shopping is performed.

FIG. 11 is a flowchart for explaining shopping support processing.

FIG. 12 is an explanatory diagram showing an example of a fruit selling space in a store.

FIG. 13 is an explanatory diagram illustrating a predetermined range.

FIG. 14 is an explanatory diagram showing commodity attribute data received from BLE terminals present in the predetermined range.

FIG. 15 is an explanatory diagram showing an example of a field of view of a supported person during execution of shopping support processing.

FIG. 16 is an explanatory diagram showing another example of the field of view of the supported person during the execution of the shopping support processing.

FIG. 17 is an explanatory diagram showing a schematic configuration of a display system in a second embodiment of the invention.

FIG. 18 is an explanatory diagram showing an example of a field of view of the supported person during the execution of the shopping support processing.

FIG. 19 is a flowchart for explaining order processing.

FIG. 20 is a main part plan view showing the configuration of an optical system included in an image display section in a modification.

### DESCRIPTION OF EXEMPLARY EMBODIMENTS

### A. First Embodiment

### A-1. Overall Configuration of a Display System

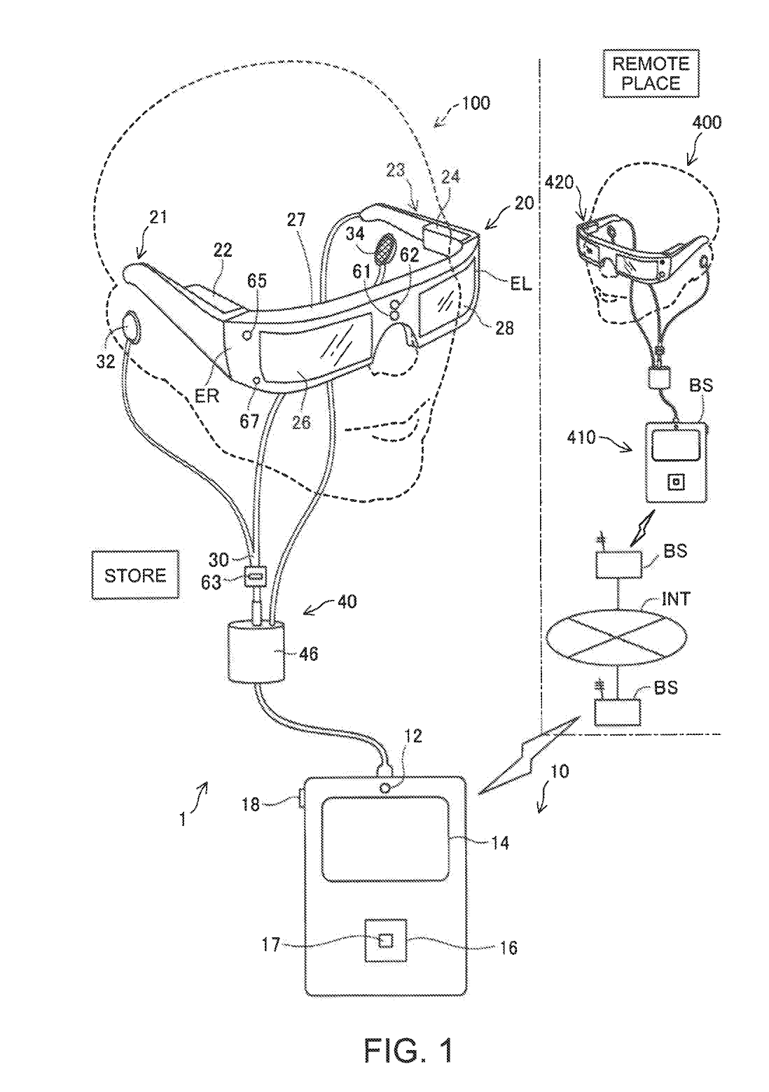

FIG. 1 is an explanatory diagram showing a schematic configuration of a display system according to a first embodiment of the invention. A display system 1 includes two head-mounted display devices 100 and 400. One head-mounted display device 100 is used by a shopping supporter in a store (a shopping venue) such as a supermarket. The other head-mounted display device 400 is used by a shopping supported person in, for example, a home away from a store.

Each of the two head-mounted display devices 100 and 400 is connected to an Internet INT by wireless communication via a communication carrier BS. The communication carrier ES includes a transmission and reception antenna, a wireless base station, and an exchange. The two head-mounted display devices 100 and 400 are capable of communicating with each other through the Internet INT. The configuration of one head-mounted display device 100, that is, the head-mounted display device 100 used by the shopping supporter in the store is explained first.

### A-2. Configuration of the Head-Mounted Display Device

The head-mounted display device 100 is a display device mounted on the head of a shopping supporter (hereinafter referred to as “user” as well) and is called head mounted display (HMD) as well. The HMD 100 is a see-through type (transmission type) head-mounted display device in which an image emerges in an outside world visually recognized through glass.

The HMD 100 includes an image display section 20 that causes the user to visually recognize an image and a control device (a controller) 10 that controls the image display section 20.

The image display section 20 is a wearing body worn on the head of the user. In this embodiment, the image display section 20 has an eyeglass shape. The image display section 20 includes a right display unit 22, a left display unit 24, right light guide plate 26, and a left light guide plate 28 in a main body including a right holding section 21, a left holding section 23, and a front frame 27.

The right holding section 21 and the left holding section 23 respectively extend backward from both end portions of the front frame 27 and, like temples of glasses, hold the image display section 20 on the head of the user. Of both the end portions of the front frame 27, an end portion located on the right side of the user in the worn state of the image display section 20 is referred to as end portion ER. An end portion located on the left side of the user is referred to as end portion EL. The right holding section 21 is provided to extend from the end portion ER of the front frame 27 to a position corresponding to the right temporal region of the user in the worn state of the image display section 20. The left holding section 23 is provided to extend from the end portion EL to a position corresponding to the left temporal region of the user in the worn state of the image display section 20.

The right light guide plate 26 and the left light guide plate 28 are provided in the front frame 27. The right light guide plate 26 is located in front of the right eye of the user in the worn state of the image display section 20 and causes the right eye to visually recognize an image. The left light guide plate 28 is located in front of the left eye of the user in the worn state of the image display section 20 and causes the left eye to visually recognize the image.

The front frame 27 has a shape obtained by coupling one end of the right light guide plate 26 and one end of the left light guide plate 28 each other. A position of the coupling corresponds to the position of the middle of the forehead of the user in the worn state of the image display section 20. In the front frame 27, a nose pad section in contact with the nose of the user in the worn state of the image display section 20 may be provided in the coupling position of the right light guide plate 26 and the left light guide plate 28. In this case, the image display section 20 can be held on the head of the user by the nose pad section and the right holding section 21 and the left holding section 23. A belt in contact with the back of the head of the user in the worn state of the image display section 20 may be coupled to the right holding section 21 and the left holding section 23. In this case, the image display section 20 can be firmly held on the head of the user by the belt.

The right display unit 22 performs display of an image by the right light guide plate 26. The right display unit 22 is provided in the right holding section 21 and located near the right temporal region of the user in the worn state of the image display section 20. The left display unit 24 performs display of an image by the left light guide plate 28. The left display unit 24 is provided in the left holding section 23 and located near the left temporal region of the user in the worn state of the image display section 20. Note that the right display unit 22 and the left display unit 24 are collectively referred to as “display driving section” as well.

The right light guide plate 26 and the left light guide plate 28 in this embodiment are optical sections (e.g., prisms) formed of light transmissive resin or the like. The right light guide plate 26 and the left light guide plate 28 guide image lights output by the right display unit 22 and the left display unit 24 to the eyes of the user. Note that dimming plates may be provided on the surfaces of the right light guide plate 26 and the left light guide plate 28. The dimming plates are thin plate-like optical elements having different transmittances depending on a wavelength region of light. The dimming plates function as so-called wavelength filters. For example, the dimming plates are disposed to cover the surface (a surface on the opposite side of a surface opposed to the eyes of the user) of the front frame 27. By appropriately selecting optical characteristics of the dimming plates, it is possible to adjust the transmittances of lights in any wavelength regions such as visible light, infrared light, and ultraviolet light. It is possible to adjust light amounts of external lights made incident on the right light guide plate 26 and the left light guide plate 28 from the outside and transmitted through the right light guide plate 26 and the left light guide plate 28.

The image display section 20 guides image lights respectively generated by the right display unit 22 and the left display unit 24 to the right light guide plate 26 and the left light guide plate 28 and causes the user to visually recognize an image (an augmented reality (AR) image) with the image lights (this is referred to as “display an image” as well). When external lights are made incident or the eyes of the user through the right light guide plate 26 and the left light guide plate 28 from the front of the user, the image lights forming the image and the external lights are made incident on the eyes of the user. Therefore, visibility of the image in the user is affected by the intensity of the external lights.

Therefore, it is possible to adjust easiness of visual recognition of the image by, for example, attaching the dimming plates to the front frame 27 and selecting or adjusting the optical characteristics of the dimming plates as appropriate. In a typical example, it is possible to select the dimming plates having light transmissivity enough for enabling the user wearing the HMD 100 to visually recognize at least an outside scene. When the dimming plates are used, it is possible to expect an effect of protecting the right light guide plate 26 and the left light guide plate 28 and suppressing damage, adhesion of stain, and the like to the right light guide plate 26 and the left light guide plate 28. The ring plates may be detachably attachable to the front frame 27 or the respective right and left light guide plates 26 and 28. A plurality of kinds of dimming plates may be replaceable and detachably attachable. The dimming plates may be omitted.

A camera 61 is disposed in the front frame 27 of the image display section 20. On the front surface of the front frame 27, the camera 61 is provided in a position for not blocking the external lights transmitted through the right light guide plate 26 and the left light guide plate 28. In the example shown in FIG. 1, the camera 61 is disposed in a coupling section of the right light guide plate 26 and the left light guide plate 28. The camera 61 may be disposed on the end portion ER side of the front frame 27 or may be disposed on the end portion EL side of the front frame 27.

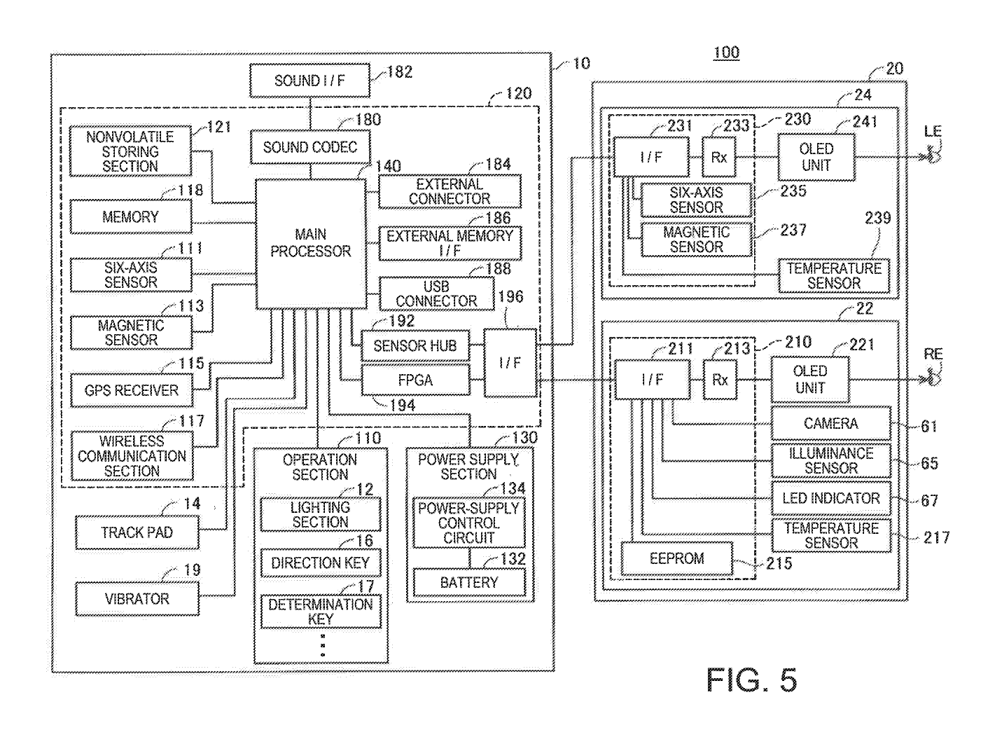

The camera 61 is a digital camera including an image pickup device such as a CCD or a CMOS and an image pickup lens. The camera 61 in this embodiment is a monocular camera. However, a stereo camera may be adopted. The camera 61 picks up an image of an outside scene (a real space) in a front side (forward) direction of the HMD 100, that is, a direction that the user is viewing in the state in which the image display section 20 is worn. In other words, the camera 61 picks up an image in a range including a line-of-sight direction of the user. The breadth of an angle of view of the camera 61, that is, the range can be set as appropriate. In this embodiment, the breadth of the angle of view of the camera 61 is set to pick up an image of the entire field of view of the user that the user can view (visually recognize) through the right light guide plate 26 and the left light guide plate 28. The camera 61 executes the image pickup according to control by a control function section 150 (FIG. 5) and outputs obtained image pickup data to the control function section 150.

A distance measuring sensor 62 is disposed in an upper part of the camera 61 in a coupled portion of the right light guide plate 26 and the left light guide plate 28 of the front frame 27. The distance measuring sensor 62 detects the distance to a measuring target object located in a measuring direction set in advance. The measuring direction can be set in the front side direction of the HMD 100 (a direction overlapping the image pickup direction of the camera 61). The distance measuring sensor 62 can be configured by, for example, a light emitting section such as an LED or a laser diode and a light receiving section that receives reflected light of light emitted by a light source and reflected on the measurement target object. In this case, a distance is calculated by triangulation processing or distance measurement processing based on a time difference. The distance measuring sensor 62 may be configured by, for example, an emitting section that emits ultrasound and a receiving section that receives the ultrasound reflected on the measurement target object. In this case, the distance is calculated by the distance measurement processing based on a time difference. Like the camera 61, the distance measuring sensor 62 is controlled by the control function section 150 and outputs a detection result to the control function section 150.

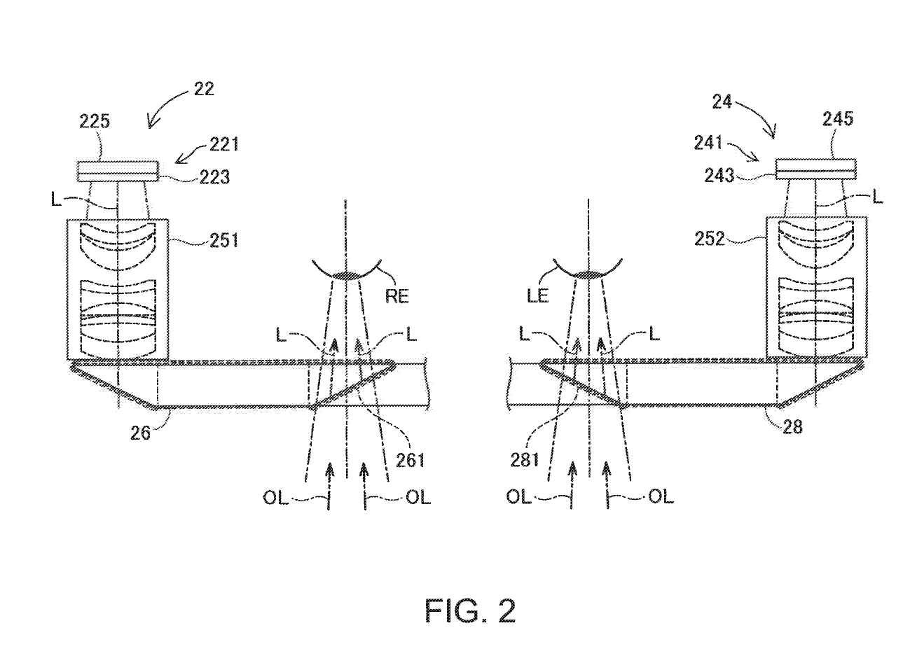

FIG. 2 is a main part plan view showing the configuration of an optical system included in the image display section 20. For convenience of explanation, a right eye RE and a left eye LE of the user are shown in FIG. 2. As shown in FIG. 2, the right display unit 22 and the left display unit 24 are configured symmetrically.

As components for causing the right eye RE to visually recognize an image (an AR image), the right display unit 22 includes an OLED (Organic Light Emitting Diode) unit 221 and a right optical system 251. The OLED unit 221 emits image light. The right optical system 251 includes a lens group and the like and guides image light L emitted by the OLED unit 221 to the right light guide plate 26.

The OLED unit 221 includes an OLED panel 223 and an OLED driving circuit 225 that drives the OLED panel 223. The OLED panel 223 is a self-emitting display panel configured by light emitting elements that emit lights with organic electroluminescence and respectively emit color lights of R (red), G (green), and B (blue). In the OLED panel 223, a plurality of pixels, one pixel of which is a unit including one each of R, G, and B elements, are arranged in a matrix shape.

The OLED driving circuit 22 executes, according to the control by the control function section 150 (FIG. 5), selection and energization of the light emitting elements included in the OLED panel 223 and causes the light emitting elements to emit lights. The OLED driving circuit 225 is fixed to the rear surface of the OLED panel 223, that is, the rear side of a light emitting surface by bonding or the like. The OLED driving circuit 225 may be configured by, for example, a semiconductor device that drives the OLED panel 223 and mounted on a substrate fixed to the rear surface of the OLED panel 223. A temperature sensor 217 (FIG. 5) explained below is mounted on the substrate. Note that the OLED panel 223 may adopt a configuration in which light emitting elements that emit white light are arranged in a matrix shape and color filters corresponding the respective colors of R, G, and B are disposed to be superimposed one on top of another. The OLED panel 223 of a WRGB configuration including a light emitting element that radiates white (W) light in addition to the light emitting elements that respectively radiate the co lights of R, G, and B may be adopted.

The right optical system 251 includes a collimate lens that changes the image light L emitted from the OLED panel 223 to a light beam in a parallel state. The image light L changed to the light beam in the parallel state by the collimate lens is made incident on the right light guide plate 26. A plurality of reflection surfaces that reflect the image light L are formed in an optical path for guiding light on the inside of the right light guide plate 26. The image light L is guided to the right eye RE side through a plurality of times of reflection on the inside of the right light guide plate 26. On the right light guide plate 26, a half mirror 261 (a reflection surface) located in front of the right eye RE is formed. After being reflected on the half mirror 261, the image light L is emitted to the right eye RE from the right light guide plate 26. The image light L forms an image on the retina of the right eye RE to cause the user to visually recognize the image.

As components for causing the left eye LE to recognize an image (an AR image), the left display unit 24 includes an OLED unit 241 and a left optical system 252. The OLED unit 241 emits the image light L. The left optical system 252 includes a lens group and the like and guides the image light L emitted by the OLED unit 241 to the left light guide plate 28. The OLED unit 241 includes an OLED panel 243 and an OLED driving circuit 245 that drives the OLED panel 243. Details of the sections are the same as the details of the OLED unit 221, the OLED panel 223, and the OLED driving circuit 225. A temperature sensor 239 is mounted on a substrate fixed to the rear surface of the OLED panel 243. Details of the left optical system 252 are the same as the details of the right optical system 251.

With the configuration explained above, the HMD 100 can function as a see-through type display device. That is, the image light L reflected on the half mirror 261 and external light OL transmitted through the right light guide plate 26 are made incident on the right eye RE of the user. The image light L reflected on a half mirror 281 and the external light OL transmitted through the left light guide plate 28 are made incident on the left eye LE of the user. In this way, the HMD 100 superimposes the image light L of the image and the external light OL processed on the inside one on top of the other and makes the image light L and the external light OL incident on the eyes of the user. As a result, for the user, an outside scene (a real world) is seen through the right light guide plate 26 and the left light guide plate 28 and an image (an AR image) by the image light L visually recognized to overlap the outside scene.

Note that the half mirror 261 and the half mirror 281 function as an “image extracting section” that reflects image lights respectively output by the right display unit 22 and the left display unit 24 and extracts an image. The right optical system 251 and the right light guide plate 26 are collectively referred to as “right light guide section” as well. The left optical system 252 and the left light guide plate 28 are collectively referred to as “left light guide section” as well. The configuration of the right light guide section and the left light guide section is not limited to the example explained above. Any system can be used as long as the right light guide section and the left light guide section form an image in front of the eyes of the user by using image light. For example, as the right light guide section and the left light guide section, a diffraction grating may be used or a semitransparent reflection film may be used.

In FIG. 1, the control device 10 and the image display section 20 are connected by a connection cable 40. The connection cable 40 is detachably connected to a connector provided in a lower part of the control device 10 and connected to various circuits inside the image display section 20 from the distal end of the left holding section 23. The connection cable 40 includes a metal cable or an optical fiber cable for transmitting digital data. The connection cable 40 may further include a metal cable for transmitting analog data. A connector 46 is provided halfway in the connection cable 40.

The connector 46 is a jack for connecting a stereo mini-plug. The connector 46 and the control device 10 are connected by, for example, a line for transmitting analog sound signal. In the example of this embodiment shown in FIG. 1, a right earphone 32 and a left earphone 34 configuring a headphone and a headset 30 including a microphone 63 are connected to the connector 46.

The microphone 63 is disposed such that a sound collecting section of the microphone 63 faces the line-of-sight direction of the user, for example, as shown in FIG. 1. The microphone 63 collects sound and outputs a sound signal to a sound interface 182 (FIG. 5). The microphone 63 may be a monaural microphone or may be a stereo microphone. The microphone 63 may be a microphone having directivity or may be a nondirectional microphone.

The control device 10 is a device for controlling the HMD 100. The control device 10 includes a lighting section 12, a touch pad 14, a direction key 16, a determination key 17, and a power switch 18. The lighting section 12 notifies an operation state (e.g., ON/OFF of a power supply) of the HMD 100 with a light emitting form of the lighting section 12. As the lighting section 12, for example, an LED (Light Emitting Diode) can be used.

The touch pad 14 detects contact operation on an operation surface of the touch pad 14 and outputs a signal corresponding to detection content. As the touch pad 14, various touch pads of various types such as an electrostatic type, a pressure detection type, and an optical type can be adopted. The direction key 16 detects pressing operation on. keys corresponding to upward, downward, left, and right directions and outputs a signal corresponding to detection content. The determination key 17 detects pressing operation and outputs a signal for determining content of operation in the control device 10. The power switch 18 detects slide operation of the switch to switch a state of the power supply of the HMD 100.

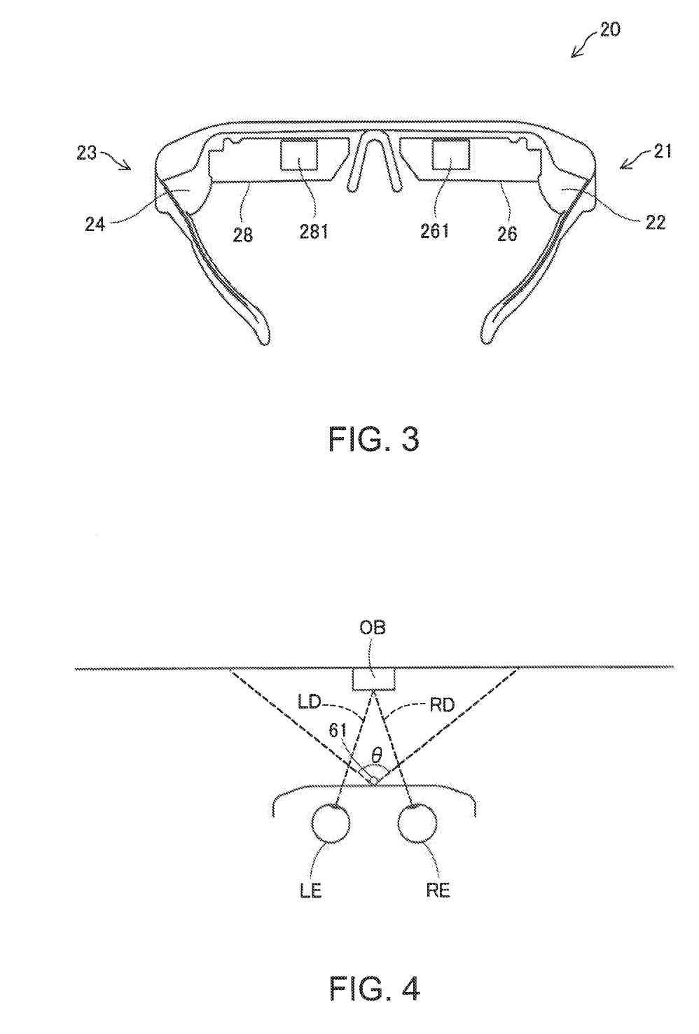

FIG. 3 is a diagram showing a main part configuration of the image display section 20 viewed from the user. In FIG. 3, the connection cable 40, the right earphone 32, and the left earphone 34 are not shown. In a state shown in FIG. 3, the rear sides of the right light guide plate 26 and the left light guide plate 28 can be visually recognized. The half mirror 261 for radiating image light on the right eve RE and the half mirror 281 for radiating image light on the left eye LE can be visually recognized as a substantially square region. The user visually recognizes an outside scene through the entire right and left light guide plates 26 and 28 including the half mirrors 261 and 281 and visually recognizes rectangular display images in the positions of the half mirrors 261 and 281.

FIG. 4 is a diagram for explaining an angle of view of the camera 61. In FIG. 4, the camera 61 and the right eve RE and the left eye LE of the user are schematically shown in plan view. An angle of view (an image pickup range) of the camera 61 is indicated by θ. Note that the angle of view θ of the camera 61 spreads in the horizontal direction as shown in the figure and spreads in the vertical direction like an angle of view of a general digital camera.

As explained above, the camera 61 is disposed in the coupling section of the right light guide plate 26 and the left light guide plate 28 in the front frame 27 of the image display section 20. The camera 61 picks up an image in the line-of-sight direction of the user (the forward direction of the user) Therefore, the optical axis of the camera 61 is set in a direction including the line-of-sight direction of the right eye RE and the left eye LE. An outside scene that the user can visually recognize in a state in which the user wears the HMD 100 is not limited to infinity. For example, when the user gazes a target object OB with both the eyes, the line of sight of the user is directed to the target object OB as indicated by signs RD and LD in the figure. In this case, the distance from the user to the target object OB is often approximately 30 cm to 10 m and is more often 1 m to 4 m. Therefore, concerning the HMD 100, standards of an upper limit and a lower limit of the distance from the user to the target object OB during normal use may be decided. The standards may be calculated in advance and preset in the MMD 100 or the user may set the standards. The optical axis and the angle of view of the camera 61 are desirably set such that the target object OB is included in the angle of view when the distance to the target object OB during the normal use is equivalent to the set standards of the upper limit and the lower limit.

Note that, in general, the angular field of view of the human is approximately 200 degrees in the horizontal direction and approximately 125 degrees in the vertical direction. An effective field of view excellent in an information reception ability in the angular field of view is approximately 30 degrees in the horizontal direction and 20 degrees in the vertical direction. A stable gazing field in which a gazing point of the human can be quickly and stably seen is considered to be approximately 60 to 90 degrees in the horizontal direction and approximately 45 to 70 degrees in the vertical direction. In this case, when the gazing point is the target object OB (FIG. 4), the effective field of view is approximately 30 degrees in the horizontal direction and 20 degrees in the vertical direction centering on the lines of sights RD and LD. The stable gazing field is approximately 60 to 90 degrees in the horizontal direction and 45 to 70 degrees in the vertical direction. An actual field of view visually recognized by the user through the image display section 20 and the right light guide plate 26 and the left light guide plate 28 is referred to as actual field of view (FOV). The actual field of view is narrower than the angular field of view and the stable gazing filed but wider than the effective field of view.

The angle of view θ of the camera 61 in this embodiment is set such that the camera 61 can perform image pickup in a range wider than the field of view of the user. The angle of view θ of the camera 61 is desirably set such that the camera 61 can perform image pickup in a range wider than at least the effective field of view of the user and is more desirably set such that the camera 61 can perform image pickup in a range wider than the actual field of view. The angle of view θ of the camera 61 is more desirably set such that the camera 61 can perform image pickup in a range wider than the stable gazing field of the user and most desirably set such that the camera 61 can perform image pickup in a range wider than the angular field of view of both the eyes of the user. Therefore, the camera 61 may include a so-called wide angle lens as an image pickup lens to be capable of performing image pickup at a wider angle of view. The wide angle lens may include lenses called super wide angle lens and semi-wide angle lens. The camera 61 may include a single focus lens, may include a zoom lens, and may include a lens group consisting of a plurality of lenses.

FIG. 5 is a block diagram functionally showing the configuration of the 100. The control device 10 includes a main processor 140 that executes a computer program to control the HMD 100, a storing section, an input/output section, sensors, an interface, and a power supply section 130. The storing section, the input/output section, the sensors, the interface, and the power supply section 130 are connected to the main processor 140. The main processor 140 is mounted on a controller board 120 incorporated in the control device 10.

The storing section includes a memory 118 and a nonvolatile storing section 121. The memory 118 configures a work area where computer programs executed the main processor 140 and data processed by the main processor 140 are temporarily stored. The nonvolatile storing section 121 is configured by a flash memory or an eMMC (embedded Multi Media Card) The nonvolatile storing section 121 stores computer programs executed by the main processor 140 and various data processed by the main processor 140. In this embodiment, the storing sections are mounted on the controller board 120.

The input/output section includes the touch pad 14 and an operation section 110. The operation section 110 includes the direction key 16, the determination key 17, and the power switch 18 included in the control device 10. The main processor 140 controls the input/output sections and acquires signals output from the input/output sections.

The sensors include a six-axis sensor 111, a magnetic sensor 113, and a GPS (Global Positioning System) receiver 115. The six-axis sensor 111 is a motion sensor (an inertial sensor) including a three-axis acceleration sensor and a three-axis gyro (angular velocity) sensor. As the six-axis sensor 111, an IMU (Inertial Measurement Unit) obtained by converting these sensors into a module may be adopted. The magnetic sensor 113 is, for example, a three-axis terrestrial magnetism sensor. The GPS receiver 115 includes a not-shown GPS antenna, receives a radio signal transmitted from the GPS satellite, and detects a coordinate of the present position of the control device 10. These sensors (the six-axis sensor 111, the magnetic sensor 113, and the GPS receiver 115) output detection values to the main processor 140 according to sampling frequency designated in advance. The sensors may output the detection values at timing corresponding to an instruction from the main processor 140.

The interface includes a wireless communication section 117, a sound codec 180, an external connector 184, an external memory interface 186, a USB (Universal Serial Bus) connector 188, a sensor hub 192, an FPGA 194, and an interface 196. These components function as interfaces with the outside. The wireless communication section 117 executes wireless communication between the HMD 100 and an external device. The wireless communication section 117 includes an antenna, an RF circuit, a baseband circuit, and a communication control circuits not shown in the figure. Alternatively, the wireless communication section 117 is configured as a device obtained by integrating these sections. The wireless communication section 117 performs, for example, wireless communication conforming to a wireless LAN including Wi-Fi (registered trademark) Bluetooth (registered trademark), and iBeacon (registered trademark).

The sound codec 180 is connected to the sound interface 182 and performs encoding and decoding of sound signals input and output via the sound interface 182. The sound interface 182 is an interface for inputting and outputting sound signals. The sound codec 180 may include an A/D converter that performs conversion from an analog sound signal into digital sound data and a D/A converter that performs conversion opposite to the conversion. The HMD 100 in this embodiment outputs sound from the right earphone 32 and the left earphone 34 and collects sound with the microphone 63. The sound codec 180 converts digital sound data output by the main processor 140 into an analog sound signal and outputs the analog sound signal via the sound interface 182. The sound codec 180 converts the analog sound signal input to the sound interface 182 into digital sound data and outputs the digital sound data to the main processor 140.

The external connector 184 is a connector for connecting an external device (e.g., a personal computer, a smartphone, or a game machine), which communicates with the main processor 140, to the main processor 140. The external device connected to the external connector 184 can be a supply source of contents and can be used for debugging of computer programs executed by the main processor 140 and collection of an operation log of the HMD 100. Various forms can be adopted as the external connector 184. As the external connector 184, for example, interfaces adapted to wired connection such as a USB interface, a micro USB interface, and an interface for a memory card and interfaces adapted to wireless connection such as a wireless LAN interface and a Bluetooth interface can be adopted.

The external memory interface 186 is an interface to which a portable memory device can be connected. The external memory interface 186 includes, for example, a memory card slot into which a card-type recording medium is inserted to perform reading and writing of data and an interface circuit. A size, a shape, a standard, and the like of the card-type recording medium can be selected as appropriate. The USB connector 188 is an interface to which a memory device, a smartphone, a cellular phone, a personal computer, and the like conforming to the USB standard can be connected. The USB connector 188 includes, for example, a connector conforming to the USB standard and an interface circuit. A size, a shape, a version of the USB standard, and the like of the USB connector 188 can be selected as appropriate.

The HMD 100 includes a vibrator 19. The vibrator 19 includes a motor and an eccentric rotor not shown in the figure and generates vibration according to control by the main processor 140. The HMD 100 causes the vibrator 19 to generate vibration in a predetermined vibration pattern, for example, when operation on the operation section 110 is detected and when the power supply of the HMD 100 is turned on and off.

The sensor hub 192 and the FPGA 194 are connected to the image display section 20 via the interface (I/F) 196. The sensor hub 192 acquires detection values of the various sensors included in the image display section 20 and outputs the detection value to the main processor 140. The FPGA 194 executes processing of data transmitted and received between the main processor 140 and the sections of the image display section 20 and transmission via the interface 196. The interface 196 is connected to the right display unit 22 and the left display unit 24 of the image display section 20. In the example in this embodiment, the connection cable 40 is connected to the left holding section 23. A wire connected to the connection cable 40 is laid inside the image display section 20. The right display unit 22 and the left display unit 24 are connected to the interface 196 of the control device 10.

The power supply section 130 includes a battery 132 and a power-supply control circuit 134. The power supply section 130 supplies electric power for the control device 10 to operate. The battery 132 is a rechargeable battery. The power-supply control circuit 134 performs detection of residual capacity of the battery 132 and control of charging to an OS 143. The power-supply control circuit 134 is connected to the main processor 140 and outputs a detection value of the residual capacity of the battery 132 and a detection value of the voltage of the battery 132 to the main processor 140. Note that electric power may be supplied from the control device 10 to the image display section 20 on the basis of the electric power supplied by the power supply section 130. A supply state of the electric power from the power supply section 130 to the sections of the control device 10 and the image display section 20 may be controllable by the main processor 140.

The right display unit 22 includes a display unit board 210, the OLED unit 221, the camera 61, an illuminance sensor 65, an LED indicator 67, and the temperature sensor 217. An interface (I/F) 211 connected to the interface 196, a receiving section (Rx) 213, and an EEPROM (Electrically Erasable Programmable Read-Only Memory) 215 are mounted on the display unit board 210. The receiving section 213 receives data input from the control device 10 via the interface 211. When receiving image data of an image displayed on the OLED unit 221, the receiving section 213 outputs the received image data to the OLED driving circuit 225 (FIG. 2).

The EEPROM 215 stores various data in a form readable by the main processor 140. The EEPROM 215 stores, for example, data concerning emission characteristics and display characteristics of the OLED units 221 and 241 of the image display section 20 and data concerning sensor characteristics of the right display unit 22 or the left display unit 24. Specifically, the EEPROM 215 stores, for example, parameters related to gamma correction of the OLED units 221 and 241 and data for compensating for detection values of the temperature sensors 217 and 239 explained below. These data are generated by inspection during factory shipment of the HMD 100 and written in the EEPROM 215. After the shipment, the main processor 140 reads the data the EEPROM 215 and uses the data for various kinds of processing.

The camera 61 executes image pickup according to a signal input via the interface 211 and outputs a signal representing picked-up image data or an image pickup result to the control device 10. As shown in FIG. 1, the illuminance sensor 65 is provided at the end portion ER of the front frame 27 and disposed to receive external light from the forward direction of the user wearing the image display section 20. The illuminance sensor 65 outputs a detection value corresponding to a light reception amount (light reception intensity). As shown in FIG. 1, the LED indicator 67 is disposed near the camera 61 at the end portion ER of the front frame 27. The LED indicator 67 is lit during the execution of the image pickup by the camera 61 to inform that the image pickup is being performed.

The temperature sensor 217 detects temperature and outputs a voltage value or a resistance value corresponding to the detected temperature. The temperature sensor 217 is mounted on the rear surface side of the OLED panel 223 (FIG. 2). The temperature sensor 217 may be mounted on, for example, a substrate on which the OLED driving circuit 225 is mounted. With this configuration, the temperature sensor 217 mainly detects the temperature of the OLED panel 223. Note that the temperature sensor 217 may be incorporated in the OLED panel 223 or the OLED driving circuit 225. For example, when the OLED panel 223 is mounted as an Si-OLED and as an integrated circuit on an integrated semiconductor chip together with the OLED driving circuit 225, the temperature sensor 217 may be mounted on the semiconductor chip.

The left display unit 24 includes a display unit board 230, the OLED unit 241, and the temperature sensor 239. An interface (I/F) 231 connected to the interface 196, a receiving section (Rx) 233, a six-axis sensor 235, and a magnetic sensor 237 are mounted on the display unit board 230. The receiving section 233 receives data input from the control device 10 via the interface 231. When receiving image data of an image displayed on the OLED unit 241, the receiving section 233 outputs the received image data to the OLED driving circuit 245 (FIG. 2).

The six-axis sensor 235 is a motion sensor (an inertial sensor) including a three-axis acceleration sensor and a three-axis gyro (angular velocity) sensor. As the six-axis sensor 235, an IMU obtained by converting the sensors into a module may be adopted. Since the six-axis sensor 235 is provided in the image display section 20, when the image display section 20 is worn on the head of the user, the six-axis sensor 235 detects a movement of the head of the user. The direction of the image display section 20 is seen from the detected movement of the head of the user. The magnetic sensor 237 is, for example, a three-axis terrestrial magnetism sensor. The temperature sensor 239 detects temperature and outputs a voltage value or a resistance value corresponding to the detected temperature. The temperature sensor 239 is mounted on the rear surface side of the OLED panel 243 (FIG. 2). The temperature sensor 239 may be mounted on, for example, a substrate on which the OLED driving circuit 245 is mounted. With this configuration, the temperature sensor 239 mainly detects the temperature of the OLED panel 243. The temperature sensor 239 may be incorporated in the OLED panel 243 or the OLED driving circuit 245. Details of the temperature sensor 239 are the same as the details of the temperature sensor 217.

The camera 61, the illuminance sensor 65, and the temperature sensor 217 of the right display unit 22 and the six-axis sensor 235, the magnetic sensor 237, and the temperature sensor 239 of the left display unit 24 are connected to the sensor hub 192 of the control device 10. The sensor hub 192 performs setting and initialization of sampling cycles of the sensors according to the control by the main processor 140. The sensor hub 192 executes energization to the sensors, transmission of control data, acquisition of detection values, and the like according to the sampling cycles of the sensors. The sensor hub 192 outputs, at timing set in advance, detection values of the sensors included in the right display unit 22 and the left display unit 24 to the main processor 140. The sensor hub 192 may include a cache function for temporarily retaining the detection values of the sensors. The sensor hub 192 may include a function of converting a signal format and a data format of the detection values of the sensors (e.g., a function of converting the signal format and the data format into unified formats). The sensor hub 192 starts and stops energization to the LED indicator 67 according to the control by the main processor 140 or extinguish the LED indicator 67.

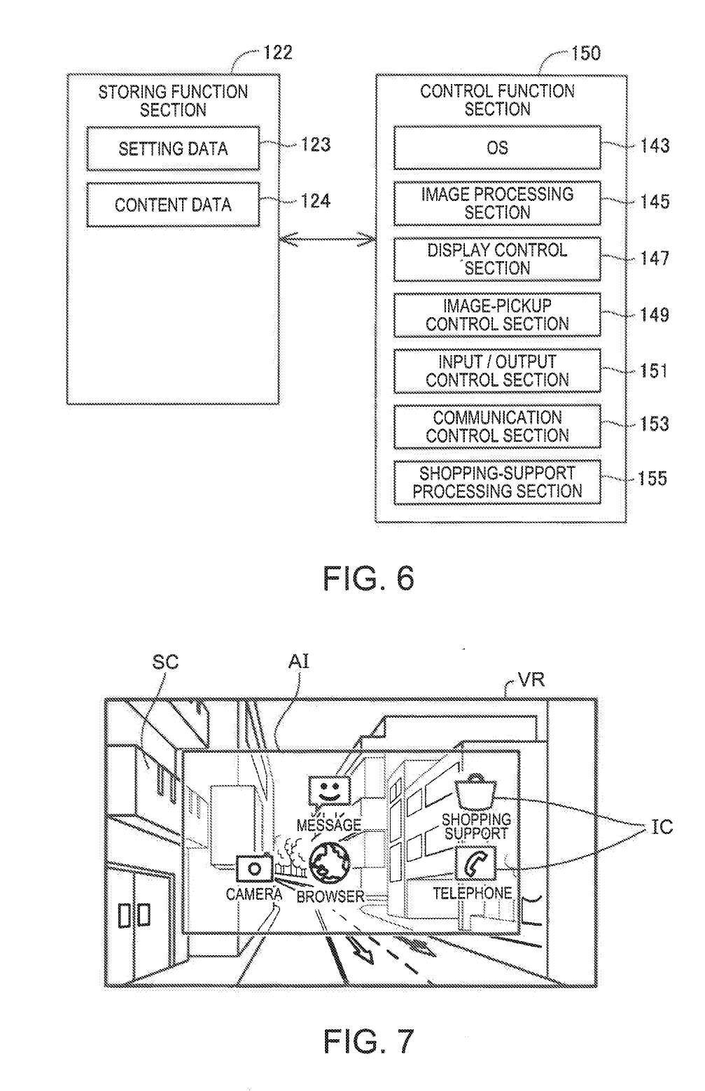

FIG. 6 is a block diagram functionally showing the configuration of the control device 10. The control device 10 functionally includes a storing function section 122 and the control function section 150. The storing function section 122 is a logical storing section configured by the nonvolatile storing section 121 (FIG. 5). The storing function section 122 may use the EEPROM 215 and the memory 118 in combination with the nonvolatile storing section 121 instead of using only the storing function section 122. The control function section 150 is configured by the main processor 140 executing a computer program, that is, hardware and software cooperating with each other.

Various data served for processing in the control function section 150 are stored in the storing function section 122. Specifically, setting data 123 and content data 124 are stored in the storing function section 122 in this embodiment. The setting data 123 includes various setting values related to the operation of the HMD 100. For example, the setting data 123 includes parameters, determinants, operational expressions, and LUTs (Look Up tables) used by the control function section 150 in controlling the HMD 100.

The content data 124 includes data (image data, video data, sound data, etc.) of contents including images and videos displayed by the image display section 20 according to the control by the control function section 150. Note that the content data 124 may include data of bidirectional contents. The bidirectional contents mean contents of a type for acquiring operation of the user with the operation section 110, executing, with the control function section 150, processing corresponding to acquired operation content, and displaying contents corresponding to processing content on the image display section 20. In this case, the data of the contents can include image data of a menu screen for acquiring the operation of the user and data for deciding processing corresponding to items included in the menu screen.

The control function section 150 executes various kinds of processing using the data stored by the storing function section 122 to thereby execute functions of the OS 143, an image processing section 145, a display control section 147, an image-pickup control section 149, an input/output control section 151, a communication control section 153, shopping-support processing section 155 In this embodiment, the functional sections other than the OS 143 are configured as computer programs executed on the OS 143.

The image processing section 145 generates, on the basis of image data of an image or a video displayed by the image display section 20, a signal transmitted to the right display unit 22 and the left display unit 24. The signal generated by the image processing section 145 may be a vertical synchronization signal, a horizontal synchronization signal, a clock signal, an analog image signal, or the like. Besides being realized by the main processor 140 executing a computer program, the image processing section 145 may be configured by hardware (e.g., a DSP (Digital Signal Processor)) separate from the main processor 140.

Note that the image processing section 145 may execute resolution conversion processing, image adjustment processing, 2D/3D conversion processing, and the like according to necessity. The resolution conversion processing is processing for converting the resolution of image data into resolution suitable for the right display unit 22 and the left ay unit 24. The image adjustment processing is processing for adjusting the luminance and the chroma of the image data. The 2D/3D conversion processing is processing for generating two-dimensional image data from three-dimensional image data or generating three-dimensional image data from two-dimensional image data. When executing these kind of processing, the image processing section 145 generates a signal for displaying an image on the basis of the image data after the processing and transmits the signal to the image display section 20 via the connection cable 40.

The display control section 147 generates a control signal for controlling the right display unit 22 and the left splay unit 24 and controls, with the control signal, generation and emission of image lights by the right display unit 22 and the left display unit 24 Specifically, the display control section 147 controls the OLED driving circuits 225 and 245 to execute display of an image by the OLED panels 223 and 243. The display control section 147 performs, on the basis of a signal output by the image processing section 145, control of timing of drawing on the OLED panels 223 and 243 by the OLED driving circuits 225 and 245, control of the luminance of the OLED panels 223 and 243, and the like.

The image-pickup control section 149 controls the camera 61 to execute image pickup, generates picked-up image data, and causes the storing function section 122 to temporarily store the picked-up image data. When the camera 61 is configured as a camera unit including a circuit that generates picked-up image data, the image-pickup control section 149 acquires the picked-up image data from the camera 61 and causes the storing function section 122 to temporarily store the picked-up image data.

The input/output control section 151 controls the touch pad 14 (FIG. 1), the direction key 16, and the determination key 17 as appropriate and acquires input commands from these sections. The acquired commands are output to the OS 143 or to the OS 143 and a computer program running on the OS 143. The communication control section 153 controls the wireless communication section 117 to perform wireless communication with, for example, the HMD 400 on the outside.

The shopping-support processing section 155 is a function realized according to an application program running on the OS 143. The shopping-support processing section 155 specifies a predetermined range including a detected line-of-sight direction of the user, performs communication with a BLE (Bluetooth Low Energy) terminal present in the specified predetermined range via the wireless communication section 117 (FIG. 5), receives data from the BLE terminal, and transmits presentation information based on the received data to the HMD 400 worn on the shopping supported person via the wireless communication section 117. Details of the shopping-support processing section 155 are explained below. Note that the shopping-support processing section 155 is equivalent to the “processing section” in the first aspect of the invention described in the summary.

FIG. 7 is an explanatory diagram showing an example of augmented reality display by the HMD 100. In FIG. 7, afield of view VR of the user is illustrated. As explained above, the image lights guided to both the eyes of the user of the HMD 100 are focused on the retinas of the user, whereby the user visually recognizes an image AI serving as the augmented reality (AR). In the example shown in FIG. 7, the image AI is a menu screen of an OS of the HMD 100. The menu screen includes, for example, icons IC for starting application programs of “message”, “telephone”, “camera”, “browser”, and “shopping support”. The right and left light guide plates 26 and 28 transmit lights from an outside scene SC, whereby the user visually recognizes the outside scene SC. In this way, concerning a portion where an image VI is displayed in the field of view VR, the user of the HMD 100 can view the image AI as overlapping the outside scene SC. Concerning a portion where the image AI is not displayed in the field of view VR, the user can view only the outside scene SC. Note that the outside scene SC shown in the figure is a town. However, since the HMD 100 is used in the store as explained above, the outside scene SC is a view in the store.

As explained above, the HMD 100 is used by the shopping supporter in the store. The other HMD 400 is used by the shopping supported person in the home away from the store. In the following explanation, the HMD 100 used by the shopping supporter is referred to as “supporter HMD 100” and the HMD 100 used by the shopping supported person is referred to as “supported person HMD 400”. The supported person HMD 400 is the same model as the supporter HMD 100. Only a part of installed application programs is different. Since a part of the application programs is different, in the supported person HMD 400, the control function section of the control device 10 is different. Note that components of the supported person HMD 400 same as the components of the supporter HMD 100 are explained below using reference numerals and signs same as the reference numerals and signs of the supporter HMD 100.

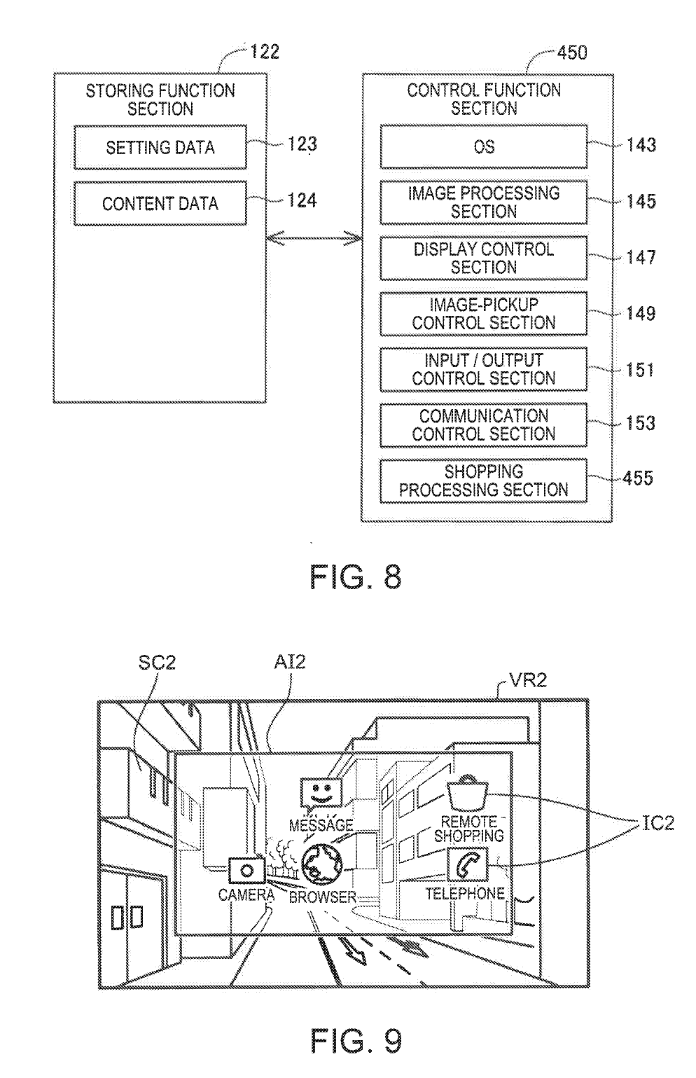

FIG. 8 is a block diagram functionally showing the configuration of the control device 10 of the supported person HMO 400. The control device 10 functionally includes the storing function section 122 and a control function section 450. The storing function section 122 is the same as the storing function section 122 of the supporter HMD 100. The control function section 450 is different from the control function section 150 of the supporter HMD 100 in that a shopping processing section 455 is provided instead of the shopping-support processing section 155. The control function section 450 is the same as the control function section 150 concerning the remaining components (143 to 153 in the figure).

The shopping processing section 455 is a function realized according to an application program running on the OS 143. The shopping processing section 455 demands shopping support and displays presentation information transmitted from the supporter HMD 100. Details of the shopping processing section 455 are explained below.

FIG. 9 is an explanatory diagram showing an example of augmented reality display by the supported person HMD 400. In FIG. 9, a field of view VR2 of a shopping supported person (hereinafter referred to as “user” as well) is exemplified. As explained above, the image lights guided to both the eyes of the user of the supported person HMD 400 are focused on the retinas of the user, whereby the user visually recognizes an image AI2 serving as augmented reality (AH). In the example shown in FIG. 7, the image AI2 is a menu screen of an OS of the supported person HMD 400. The menu screen includes, for example, icons IC2 for starting application programs of “message”, “telephone”, “camera”, “browser”, and “remote shopping”. The right and left light guide plates 26 and 28 transmit lights from an outside scene SC2, whereby the user visually recognizes the outside scene SC2, In this way, concerning a portion where an image VI2 is displayed in the field of view VR2, the user of the supported person HMD 400 can view the image 412 as overlapping the outside scene SC2. Concerning a portion where the image AI2 is not displayed in the field of view VR2, the user can view only the outside scene SC2. Note that the outside scene SC2 shown in the figure is a town. However, since the supported person HMD 400 is used in the home as explained above, the outside scene SC2 is a view in the home.

### A-3. Processes Concerning Shopping

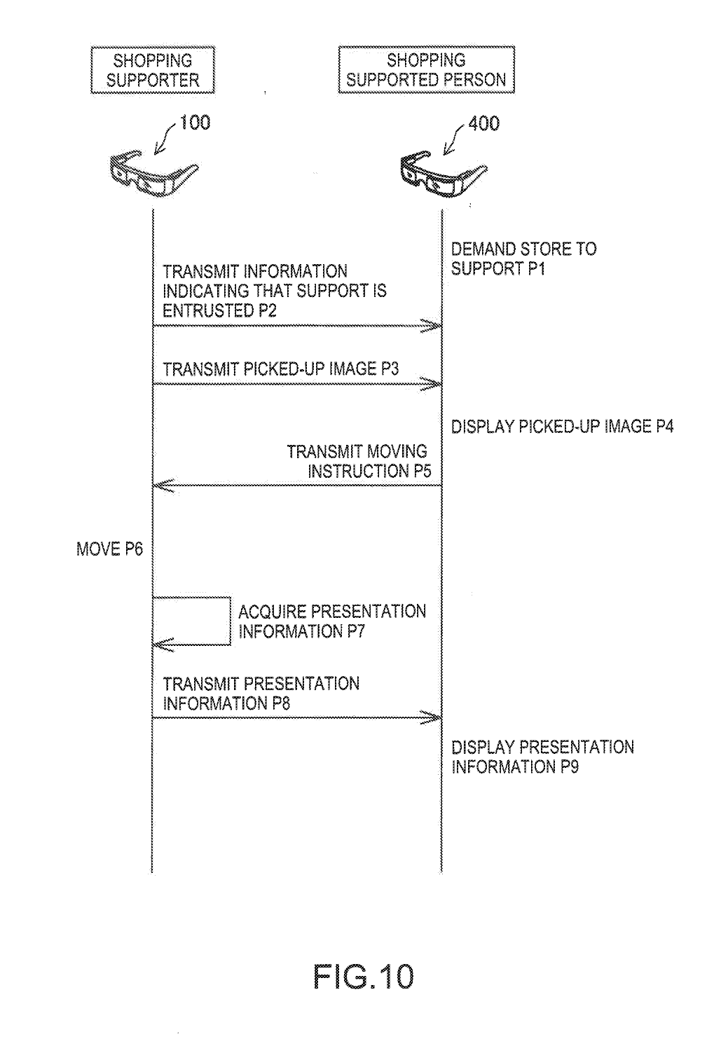

FIG. 10 is an explanatory diagram showing processes executed on the supported person HMD 400 side and the supporter HMD 100 side when shopping is performed. When the shopping is performed, first, the shopping supported person (hereinafter simply referred to as “supported person” as well) wearing the supported person HMD 400 demands the store to support the shopping (step P1). Specifically, the supported person points, with the direction key 16 (FIG. 1) and the determination key 17 (FIG. 1), the icon IC2 of “remote shopping” prepared on the menu screen to thereby perform communication with a cellular phone terminal via the USB connector 188 (FIG. 5) and call the store registered in advance. The supported person demands, with the telephone, the store to support the shopping. The demand for the support can also be performed by other communication means such as a mail instead of the telephone.

The store receiving the demand for the shopping support instructs the shopping supporter (hereinafter simply referred to as “supporter” as well) wearing the supporter HMD 100, who is on standby in advance in the store, to perform the shopping support. The instructed supporter establishes communication between the supporter HMD 100 and the supported person HMD 400 and then transmits, to the supported person HMD 400 worn by the shopping supported person, information indicating that the shopping support is entrusted (step P2). The communication between the supporter HMD 100 and the supported person HMD 400 includes not only data transfer but also a voice call.

Further, the supporter HMD 100 transmits a picked-up image picked up by the camera 61 to the supported person RED 400 (step P3).

The supported person HMD 400 receives the picked-up image transmitted from the supporter HMD 100 and displays the received picked-up image (step P4). Specifically, the supported person HMD 400 controls the image processing section 145 (FIG. 6) on the basis of the picked-up image and causes the display control section 147 (FIG. 6) to execute display of the picked-up image. As a result, the picked-up image picked up by the supporter HMD 100 is displayed on the supported person HMD 400. Consequently, the supported person wearing the supported person HMD 400 can view an image in the store while staying in the home. Note that, thereafter, picked-up images are continuously transmitted from the supporter HMD 100 to the supported person HMD 400 until the shopping support ends. The supported person can sequentially view situations in the store with the supported person HMD 400.

The supported person views the inside of the store in order while gazing at commodities. At this point, the supported person transmits an instruction to the supporter HMD 100 using the supported person HMD 400 (step P5). Specifically, the supported person transmits, with a voice call, information indicating that the supported person moves to a desired selling space to the supporter HMD 100. For example, the supported person transmits an instruction such as “I want fruits”.

The instructed supporter moves on the sis of the instruction (step P6). For example, the supporter moves to the fruit selling space. Subsequently, the supporter HMD 100 acquires presentation information for each of types of commodities around the line-of-sight direction of the supporter (step P7) and transmits the acquired presentation information to the supported person HMD 400 (step P8). It is explained below how the presentation information is acquired.

The supported person HMD 400 receives the presentation information transmitted from the supporter HMD 100 and displays the presentation information (step P9). Specifically, the supported person HMD 400 controls the image processing section 145 (FIG. 6) of the supported person HMD 400 on the basis of the presentation information and causes the display control section 147 (FIG. 6) of the supported person HMD 400 to execute display of the presentation information. The presentation information is displayed to be superimposed on the picked-up image displayed in step P4. Steps P1, P4, and P9 executed by the supported person HMD 400 correspond to the shopping processing section 455 (FIG. 8).

The supported person wearing the supported person HMD 400 views the displayed presentation information and orders a commodity of a favorite type. The supported person transmits, for example, with a voice call, the order of the commodity to the supporter HMD 100.

### A-4. Shopping Support Processing

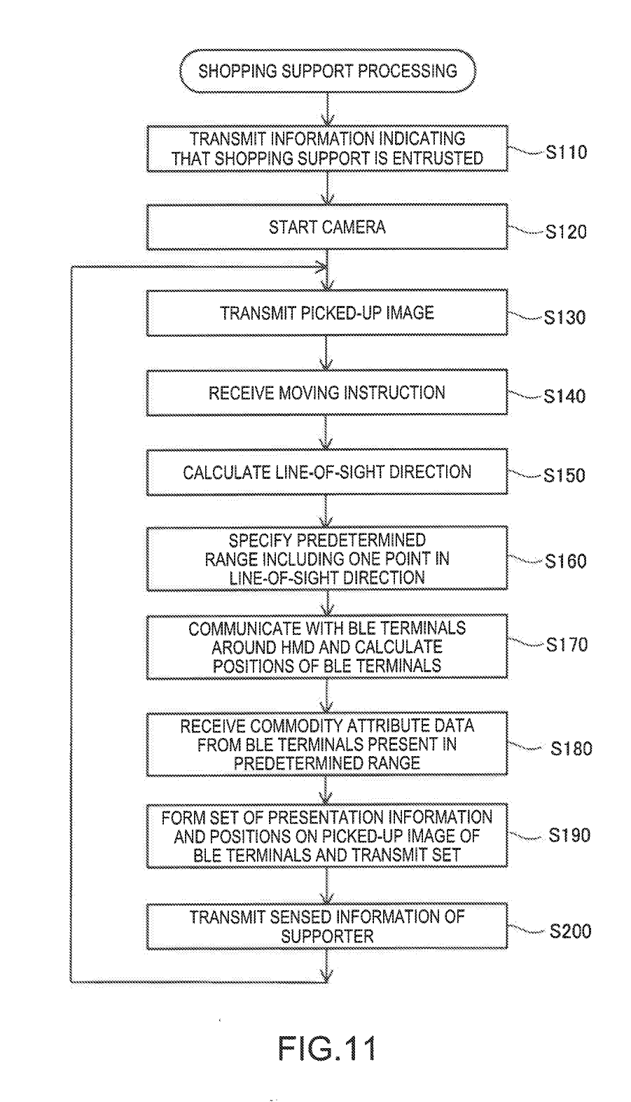

FIG. 11 is a flowchart for explaining shopping support processing. The shopping support processing corresponds to the shopping-support processing section 155 (FIG. 6) and realizes steps P2, P3, P7, and P8 shown in FIG. 10. The shopping support processing is a processing routine conforming to a predetermined computer program (application program) stored in the nonvolatile storing section 121 (FIG. 5) and is executed by the main processor 140 of the supporter HMD 100. The shopping support processing starts to be executed in response to pointing of the icon IC of “shopping support” of the menu screen illustrated in FIG. 7 by the direction key 16 (FIG. 1) and the determination key 17 (FIG. 1).

When the processing is started, first, the main processor 140 of the supporter HMD 100 establishes communication between the supporter HMD 100 and the supported person HMD 400 and then transmits, to the supported person HMD 400 worn by the shopping supported person, a message to the effect that the shopping support is entrusted (step S110). This processing is equivalent to step P2 in FIG. 10.

Subsequently, the main processor 140 starts the camera 61 (step S120) and transmits an image picked up by the camera 61 to the supported person HMD 400 (step S130). As explained above, the image picked up by the camera 61 is obtained by performing image pickup in a range wider than the field of view of the supporter. Therefore, the main processor 140 deletes the periphery of the picked-up image to match the picked-up image to the field of view of the supporter and then transmits the picked-up image to the supported person HMD 400. That is, an image matching the field of view of the supporter is transmitted to the supported person HMD 400. The processing in step S130 is equivalent to step P3 in FIG. 10. Note that, thereafter, the picked-up image continues to be transmitted until the shopping support ends.

Subsequently, when an instruction is transmitted from the supported person HMD 400, the main processor 140 receives the instruction (step S140). For example, the main processor 140 receives an instruction such as “I want fruits”. This processing is processing on the supporter HMD 100 side corresponding to step P5 in FIG. 10.

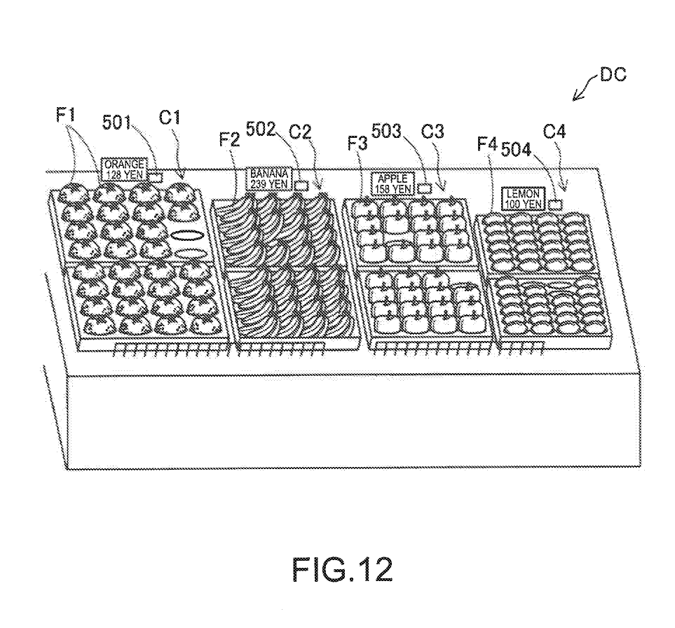

FIG. 12 is an explanatory diagram showing an example of the fruit selling space in the store. According to step P6 shown in FIG. 10, the supporter moves to, for example, the fruit selling space. A showcase DC is provided in the fruit selling space. In the showcase DC, fruits F1, F2, F3, and. F4 are classified for each of types and displayed. For example, first fruits F1 are oranges, second fruits F2 are bananas, third fruits F3 are apples, and fourth fruits F4 are lemons. For example, a group C1 of oranges, a group C2 of bananas, a group C3 of apples, and a group C4 of lemons are arrayed from the left to the right of the showcase DC. At the upper ends of the groups C1, C2, C3, and C4, BLE terminals 501, 502, 503, and 504 are respectively provided, BLE (Bluetooth Low Energy) is one of extended specifications of the short-range wireless communication technique Bluetooth (registered trademark). In the BLE, communication is possible with minimum power. The wireless communication section 117 (FIG. 5) of the supporter HMD 100 is capable of performing communication with the BLE terminals. The supporter wearing the supporter HMD 100 moves to the front of the showcase DC according to a movement instruction from the supported person.

Referring back to FIG. 11, thereafter, the main processor 140 calculates a line-of-sight direction of the user (the supporter) wearing the image display section 20 (step S150). The “line-of-sight direction” is a direction that the user is viewing. In step S150, assuming that the direction of the image display section 20 coincides with the line-of-sight direction of the user, the main processor 140 specifies the direction of the image display section 20 from a detection signal of the six-axis sensor 235 equipped in the image display section 20 to thereby calculate the line-of-sight direction. The “line-of-sight direction” is also considered to be a direction connecting the center between the left eye and the right eye and a target. (one point) that the user is viewing with both the eyes. The six-axis sensor 235 is equivalent to the “specific-direction detecting section” in the aspect of the invention described in the summary. The line-of-sight direction is equivalent to the “specific direction” in the aspect.

Subsequently, the main processor 140 specifies a predetermined range including the line-of-sight direction calculated in step S150 (step S160). In this embodiment, the main processor 140 specifies one point in the line-of-sight direction and specifies a predetermined range centering on the one point. When an object is present in the line-of-sight direction, the “one point in the line-of-sight direction” is a point on the surface of the object crossing the line-of-sight direction. When an object is absent in the line-of-sight direction, the “one point in the line-of-sight direction” is a point away from the user by a predetermined distance (e.g., 5 m) on the line-of-sight direction.

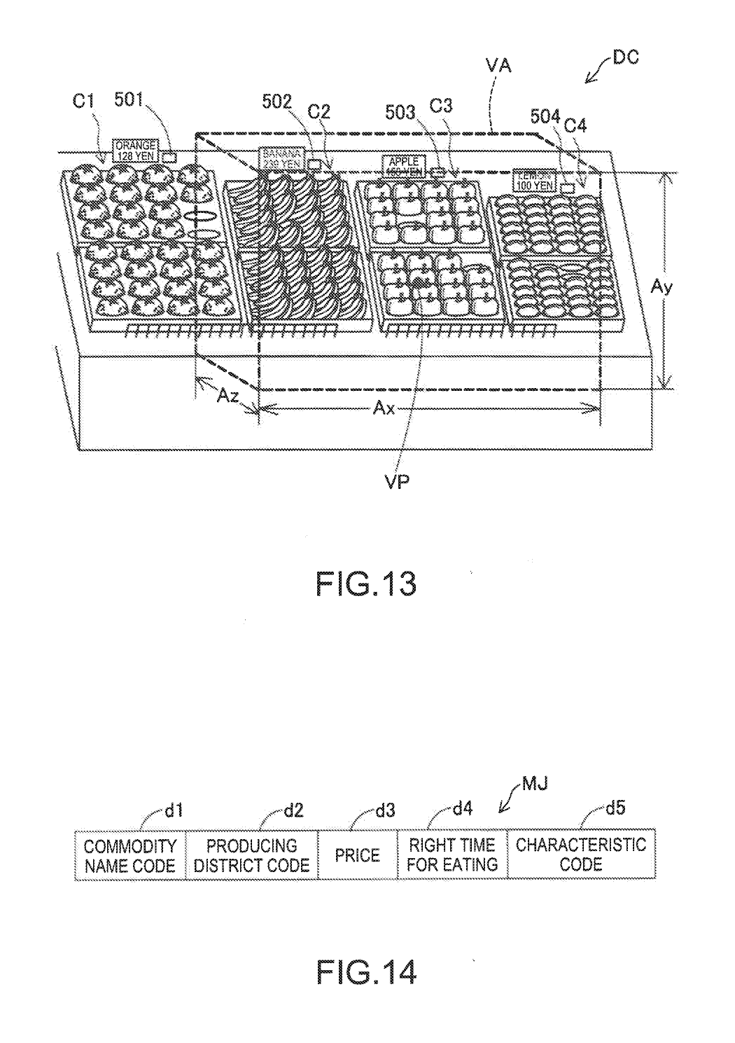

FIG. 13 is an explanatory diagram illustrating a predetermined range VA. The predetermined range VA is a rectangular parallelepiped region. One point VP in the line-of-sight direction is located in the center of the rectangular parallelepiped. In step S160, specifically, the main processor 140 calculates, on the basis of the line-of-sight direction calculated in step S150 and the distance detected by the distance measuring sensor 62, the one point VP that the user is viewing and decides a region extended from the one point to the left side by ½ Ax, to the right side by ½ Ax, to the upper side by ½ Ay, to the lower side by ½ Ay, to the depth side by ½ Az, and to the near side by ½ Az as the predetermined range VA. Ax, Ay, and Az are predetermined values. There values may be values that change according to a position in the store. For example, in the position of a booth in which large commodities are displayed, Ax, Ay, and Az may be set to large values. In the position of a booth in which small commodities are displayed, Ax, Ay, and Az may be set to small values. In this embodiment, Ax, Ay, and Az are stored in the nonvolatile storing section 121 (FIG. 5). In the illustration in FIG. 13, the one point VP is located around a lower part of the group C3 of apples. The predetermined range VA is a range including the group C2 of bananas, the group C3 of apples, and the group C4 of lemons.

Note that the predetermined range VA does not need to be limited to the predetermined range. For example, the predetermined range may be displayed on the image display section 20. The range can be enlarged and reduced or moved on the basis of an operation command of the user from the control device 10.

Referring back to FIG. 11, subsequently, the main processor 140 requests a plurality of BLE terminals (in the illustration in FIG. 12, 501 to 504) present around the supporter HMD 100 to establish connection. After the connection is established, the main processor 140 performs data transmission and reception (communication) with the connected BLE terminals 501 to 504 to calculate relative positions of the BLE terminals 501 to 504 relative to the supporter HMD 100 (step S170). Subsequently, the main processor 140 selects, on the basis of the calculated relative positions of the BLE terminals 501 to 504, out of the plurality of BLE terminals 501 to 504, BLE terminals located within the predetermined range calculated in step S160 and performs data transmission and reception with the selected BLE terminals to receive commodity attribute data (step S180). In the illustration in FIG. 13, the BLE terminal 502 for the group C2 of bananas, the BLE terminal 503 for the group C3 of apples, and the BLE terminal 504 for the group C4 of lemons are included in the predetermined range VA. Therefore, the main processor 140 receives commodity attribute data from the BLE terminals 502 to 504.

FIG. 14 is an explanatory diagram showing commodity attribute data MJ received from the BLE terminals 502 to 504 present within the predetermined range. The commodity attribute data MJ are numerical value data separately prepared for each of types of commodities and includes items d1 to d5 of “commodity name code”, “producing district code”, “price”, “right time for eating”, and “characteristic code”. The item d1 of the “commodity name code” is a code indicating a name of the commodity. The item d2 of the “producing district code” is a code indicating a producing district of the commodity. The item d3 of the “price” indicates a price of the commodity. The item d4 of the “right time for eating” indicates a period when the commodity is good for eating. The item d5 of the “characteristic code” indicates a characteristic of the commodity. The types of the items d1 to d5 may be optionally decided. In step S180 in FIG. 11, the main processor 140 receives the individual commodity attribute data MJ from the respective BLE terminals 502 to 504 located within the predetermined range.

In the nonvolatile storing section 121 (FIG. 5), a table indicating a correspondence relation between a commodity name code and a commodity name (a character string), a table indicating a correspondence relation between a producing district code and a producing district name (a character string), a table indicating a correspondence relation between a characteristic code and a characteristic (a character string), and the like are stored in advance. In the subsequent step S190, the main processor 140 compares the items d1, d2, and of the codes in the received commodity attribute data with the table to thereby convert the items d1, d2, and d5 into character strings, sets, as presentation information, the commodity attribute data obtained by converting code portions obtained in that way into character strings, forms a set of data indicating the positions on a picked-up image of the BLE terminals 502 to 504 and the presentation information, and then transmits the set of the data and the presentation information to the supported person HMD 400. Specifically, the main processor 140 calculates positions on the picked-up image of the BLE terminals 502 to 504 present in the predetermined range VA from the relative positions of the BLE terminal selected in step S170, links the positions on the picked-up image of the BLE terminals 502 to 504 with the presentation information generated on the basis of the commodity attribute data received from the BLE terminals 502 to 504 and transmits the linked data of the set to the supported person HMD 400.

Subsequently, the main processor 140 starts the microphone 63 (FIG. 1), acquires voice of the supporter with the microphone 63, and transmits data of the acquired voice to the supported person HMD 400 (step S200). If the supporter feels about the commodity in a tactile sense, a gustatory sense, or an olfactory sense, the supporter utters what the supporter feels. For example, if the supporter smells the commodity and the smell has a characteristic, the supporter utters an impression concerning the smell. If the supporter touches the commodity and the commodity has a characteristic in the touch, the supporter utters an impression concerning the touch. For example, if the user can taste the commodity, the user tastes the commodity and utters an impression concerning the taste. In step S200, the main processor 140 acquires, with the microphone 63, the voice of the supporter and transmits data of the acquired voice to the supported person HMD 400. Note that the main processor 140 does not always need to execute, at this timing, the processing for acquiring sound with the microphone 63 and transmitting data of the acquired sound to the supported person HMD 400. For example, the main processor 140 may start transmitting sound when starting to transmit the picked-up image in step S130 and thereafter continue to acquire and transmit sound until the shopping support processing ends.

After the execution of step S200, the main processor 140 returns the processing to step S130 and repeatedly executes the processing in step S130 and subsequent steps. The main processor 140 executes the repetition until the shopping ends.

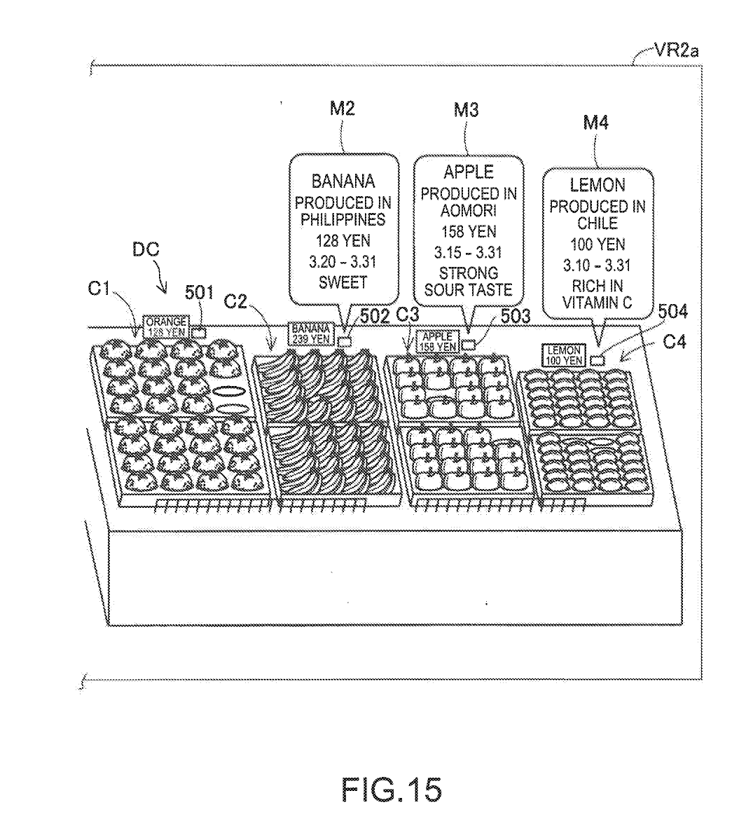

FIG. 15 is an explanatory diagram showing an example of a field of view of the supported person during the execution of the shopping support processing. When the shopping support processing is executed in the supporter HMD 100, for example, an image shown in the figure is displayed in a field of view (a visual field) VR2a of the supported person wearing the supported person HMD 400 that operates in cooperation with the supporter HMD 100. The image is a picked-up image transmitted from the supporter HMD 100 in step S130 (FIG. 11). In the field of view e visual field) VR2a, an image same as the image that the supporter is viewing (see FIG. 12) through the right and left light guide plates 26 and 28 of the supporter HMD 100 appears.

Further, in the field view VR2a, presentation information concerning the fruit groups C2 to C4 included in the predetermined range VA (see FIG. 13) explained above is displayed. The presentation information is created on the basis of the data of the set transmitted from the supporter HMD 100 in step S190 (FIG. 11). Specifically, the main processor 140 displays the presentation information included in the data of the set in the positions on the picked-up image of the BLE terminals 502 to 504 included in the data of the set. That is, the main processor 140 displays presentation information M2 obtained from the BLE terminal 502 of the group C2 of banana in the position of the BLE terminal 502. The main processor 140 displays presentation information M3 obtained from the BLE terminal 503 of the group C3 of apples in the position of the BLE terminal 503. The main processor 140 displays presentation information M4 obtained from the BLE terminal 504 of the group C4 of lemons in the position of the BLE terminal 504. The presentation information M2 to M4 indicates commodity names, producing districts, prices, right times for eating, and characteristics.

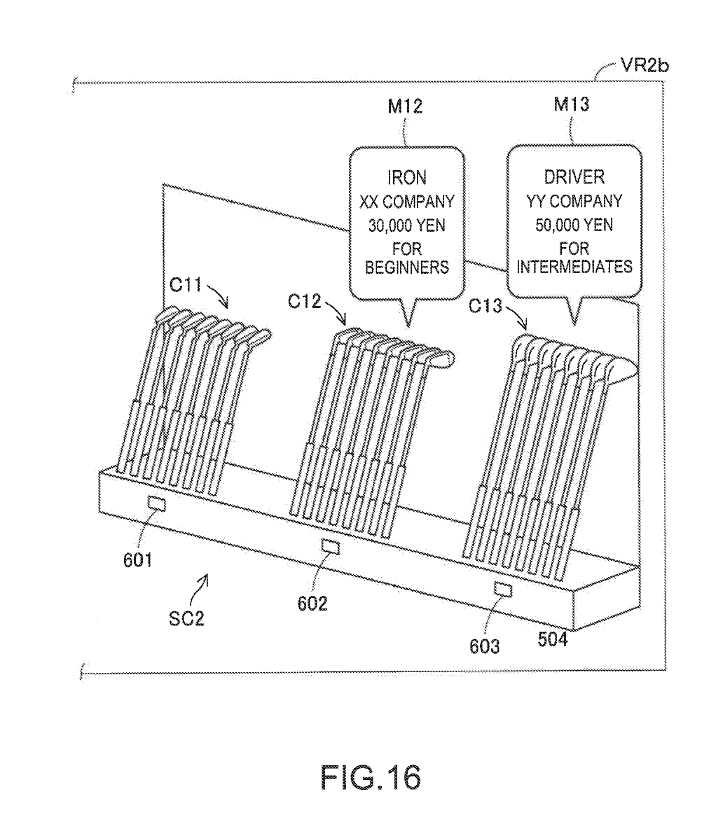

FIG. 16 is an explanatory diagram showing another example of the field of view of the supported person during the execution of the shopping support processing. When the supporter wearing the supporter HMD 100 moves to a golf club selling space, for example, an image shown in the figure is displayed in a field of view (a visual field) VR2b of the supported person wearing the supported person HMD 400 that operates in cooperation with the supporter HMD 100. The image is an image indicating the golf club selling space. In the field of view VR2b, an image same as the image (see FIG. 12) that the supporter is viewing through the right and left light guide plates 26 and 28 of the supporter HMD 100 appears.

Further, in the field of view VR2a, presentation information concerning golf club groups included in a predetermined range (not shown in the figure) including the line-of-sight direction, in the example shown in the figure, a group C12 of “irons” and a group C13 of “drivers” are displayed. The presentation information is created on the basis of data of a set transmitted from the supporter HMD 100. Specifically, the presentation information included in the data of the set is displayed in positions associated with the positions on a picked-up image of BLE terminal 602 and 603 included in the data of the set. Specifically, the position of a golf club group corresponding to the BLE terminal 602 is specified by pattern recognition of the image on the basis of the position on the picked-up image of the BLE terminal 602 of the group C12 of irons. Presentation image M12 is displayed with an upper part of the specified position set as an “associated position”. Presentation information M13 obtained from the BLE terminal 603 of the group C13 of drivers is also displayed in a position based on the position of the BLE terminal 603.

### A-5. Effect of the Embodiment

With the supporter HMD 100 in this embodiment configured as explained above, the presentation information based on the commodity attribute data received from the BLE terminals 502 to 504 present in the predetermined range VA including the one point VP in the line-of-sight direction of the user can be transmitted to the supported person HMD 400. Therefore, the supported person wearing the supported person HMD 400 can receive information around the line-of-sight direction of the user wearing the supporter HMD 100 while staying in a position away from the user. Therefore, the supporter HMD 100 in this embodiment can appropriately and efficiently present information in the line-of-sight direction to the supported person present in the position away from the user.

In this embodiment, since the information processing device used by the supported person is the HMD, the supported person can visually recognize an image coinciding with an image visually recognized by the supporter who uses the supporter HMD 100. Therefore, the supported person can purchase a commodity in feeling of actually performing shopping in the store. In particular, in this embodiment, since the HMD is a binocular type, the supported person can share, with the supporter, stereoscopic 3D feeling such as depth feeling.

### B. Second Embodiment

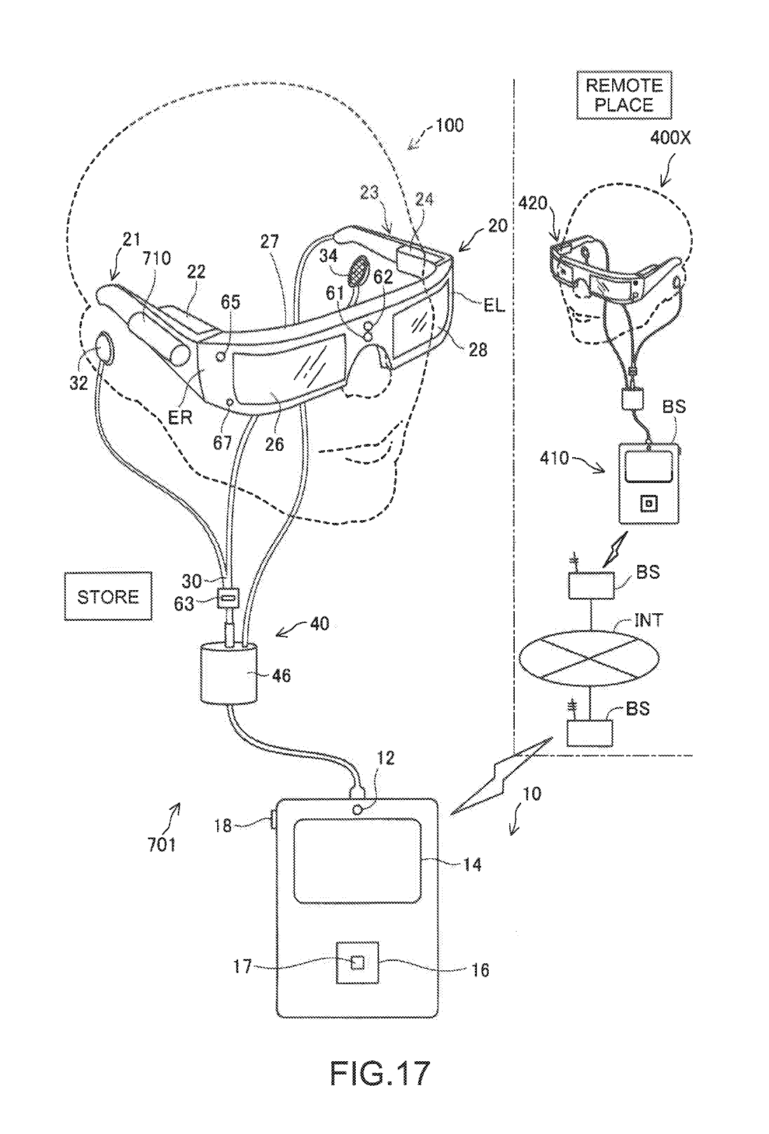

FIG. 17 is an explanatory diagram showing a schematic configuration of a display system in a second embodiment of the invention. A display system 701 in the second embodiment includes an HMD 100X used by a shopping supporter and an HMD 400X used by a shopping supported person. The HMD 100X is different from the HMD 100 in the first embodiment in that the HMD 100X includes a telephotographic camera 710. Otherwise, the HMD 100X is the same as the HMD 100. Components of the HMD 100X same as the components of the HMD 100 in the first embodiment are denoted by reference numerals and signs same as the reference numerals and signs of the components of the HMD 100. Explanation of the components is omitted.

In the HMD 100X, the telephotographic camera 710 is provided in the right holding section 21. Specifically, the telephotographic camera 71 is provided along the longitudinal direction of the right holding section 21. The telephotographic camera 710 can photograph at least a photographing range of the camera 61 provided on the front surface of the front frame 27. The telephotographic camera 710 can move and enlarge a focus area. The movement and the enlargement of the focus area are operated from a remote place by the HMD 400X. The telephotographic camera 710 may be provided in the left holding section 23 instead of the right holding section 21. The telephotographic camera 710 does not need to be limitedly provided in the right holding section 21 or the left holding section 23 and may be provided in any position of the image display section 20 as long as the telephotographic camera 710 can photograph the photographing range of the camera 61.

The MMD 400X used by the shopping supported person is different from the HMD 400 in the first embodiment in that the telephotographic camera 710 of the HMD 100X can be operated from a remote plate and order processing explained below can be executed. Otherwise, the MMD 400X is the same as the HMD 400. Components of the HMD 400X same as the components of the HMD 400 in the first embodiment are denoted by reference numerals and signs same as the reference numerals and signs of the components of the MMD 400. Explanation of the components is omitted.

In the second embodiment, the configurations of commodities displayed in a store are different from the configurations in the first embodiment. Specifically, QR codes (registered trademark) are attached to the commodities in the second embodiment. In the QR code, start information for starting a settlement application gram (e.g., a URL of a Web page for performing settlement processing) and commodity information including a price are coded and recorded.

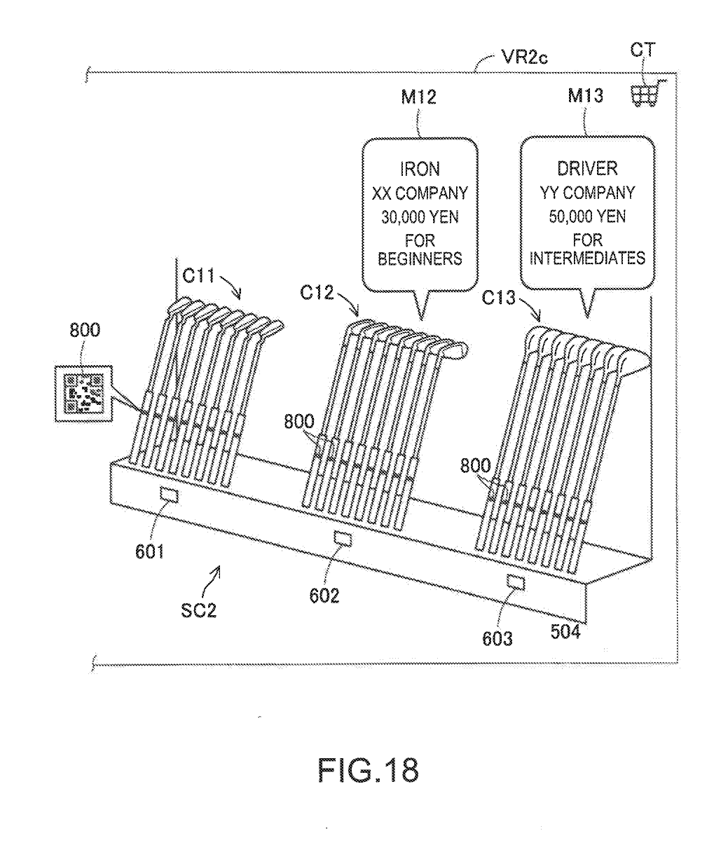

FIG. 18 is an explanatory diagram showing an example of a field of view of the supported person during execution of shopping support processing. In the second embodiment, shopping support processing same as the shopping support processing in the first embodiment is executed. When the supporter wearing the HMD 100X moves to a golf club selling space, an image same as the image in the first embodiment displayed in the field of view (the visual field) VR2b of the supported. person wearing the HMD 400X that operates in cooperation with the HMD 100X. As it is seen from the figure, the QR codes 800 described above are stuck to shaft portions of golf clubs, which are commodities. A cart mark CT is displayed at the right upper corner of a display screen of the HMD 400X on the supported person side.

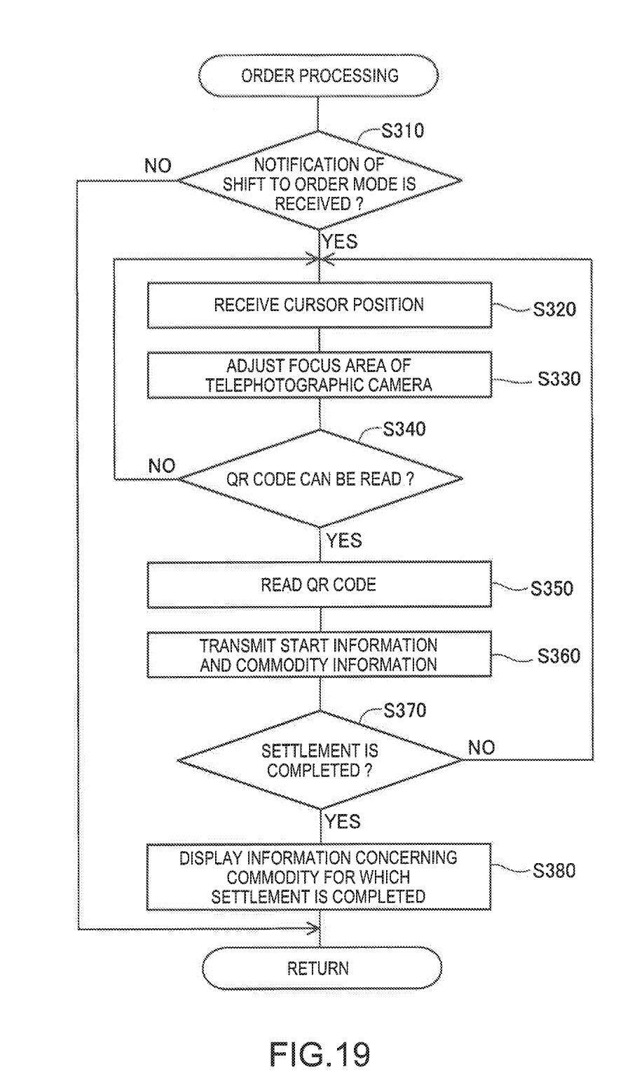

FIG. 19 is a flowchart for explaining the order processing. The order processing is executed by a main processor of the HMD 100X used by the shopping supporter (hereinafter referred to as “supporter HMD 100X”). The order processing is executed by interruption after the execution of step S200 in the shopping support processing in FIG. 11. When the processing is started, first, the main processor of the supporter HMD 100X determines whether a notification of a shift to an order mode is received from the HMD 400X used by the shopping supported person (hereinafter referred to as “supported person HMD 400X”) (step S310). The supported person HMD 400X transmits the notification of the shift to the order mode to the supporter HMD 100X in response to pointing of the cart mark CT by the direction key 16 (FIG. 1) and the determination key 17 (FIG. 1) on the display screen illustrated in FIG. 18. In step S310, the main processor determines whether the notification is received.

When determining in step S310 that the notification of the shift to the order mode is received, the main processor receives a cursor position on the display screen in the supported person HMD 400X from the supported person HMD 400X (step S320). Subsequently, the main processor starts photographing by the telephotographic camera 710 and adjusts a focus area of the telephotographic camera 710 according to the received cursor position (step S330). That is, the focus area of the telephotographic camera 710 is remotely operated by the supported person who uses the supported person HMD 400X.

Subsequently, the main processor determines whether the QR code 800 can be read from a photographed image of the telephotographic camera 710 (step S340). When determining that the QR code 800 can not be read, the main processor returns the processing to step S320 and repeats the processing in steps S320 to S340. That is, the main processor waits for the QR code 800 to be pointed by the supported person who uses the supported person HMD 400X. When the QR code 800 can be read in step S340, the main processor advances the processing to step S350.

In step S350, the main processor performs processing for reading the QR code 800 from the photographed image obtained by the telephotographic camera 710. As a result, the main processor can acquire start information of a settlement application program and commodity information including a price recorded in QR code 800. Thereafter, the main processor transmits the acquired start information and commodity information to the supported person HMD 400X (step S360).

The supported person HMD 400X receives the start information and the commodity information transmitted from the supporter HMD 100X and performs settlement processing on the basis of these kinds of information. Specifically, the supported person HMD 400X starts the settlement application program on the basis of the start information and executes settlement according to credit card information registered in the settlement application program in advance. When the settlement is completed, the supported person HMD 400X transmits a notification to the effect that the settlement is completed to the supporter HMD 100X.

After the execution of step S360, the main processor of the supporter HMD 100X determines whether the settlement is completed on the supported person HMD 400X side (step S370) Specifically, the main processor performs the determination according to whether the notification to the effect that the settlement is completed is transmitted from the supported person HMD 400X. When determining that the settlement is not completed, the main processor returns the processing to step S320 and executes the processing again according to reception of a cursor position.

When determining in step S370 that the settlement is completed, the main processor causes the image display section 20 to display commodity information concerning a commodity for which the settlement is completed (step S380) Consequently, the supporter wearing the supporter HMD 100X can receive an order instruction for the commodity from the supported person HMD 400X.

After the execution of step S380, the main processor advances the processing to “return” and once ends the order processing. When determining in step S310 that the notification of the shift to the order mode is not received, the main processor also advances the processing to “return” and once ends the order processing.

With the supporter HMD 100X in the second embodiment configured as explained above, as in the first embodiment, it is possible to appropriately and efficiently present information in the line-of-sight direction to the supported person present in a position away from the user. Further, with the supporter HMD 100X in the second embodiment, it is possible to easily receive an order instruction for a commodity. On the other hand, with the supported person HMD 400X cooperating with the supporter HMD 100X, it is possible to easily perform processing up to settlement of the commodity.

Note that, in the order processing in the second embodiment, the settlement is performed for each of commodities. However, the settlement may be performed collectively for a plurality of commodities.

### C. MODIFICATIONS

Note that the invention is not limited to the embodiments and modifications of the embodiments. It is possible to carry out the invention in various forms without departing from the spirit of the invention. For example, modifications explained below are also possible.

### Modification 1

In the embodiments and the modifications, the specific-direction detecting section is configured by the six-axis sensor 235 equipped in the image display section 20. However, the specific-direction detecting section is not limited to this and can be variously modified. For example, the specific-direction detecting section may be a camera for eyeball photographing. The line-of-sight direction of the user is detected by picking up, using the camera for eyeball photographing, an image of the left and right eyeballs of the user in a state in which the head-mounted display device is mounted and analyzing an obtained image of the eyeballs. For example, the line-of-sight direction is detected by calculating a center position of the pupil from the eyeball image. In the analysis of the eyeball image, slight shakes and flicks of the eyes that involuntarily occur even if a human believes that the human is staring a gazing point may be taken into account.

### Modification 2

In the embodiments and the modifications, the rectangular parallelepiped region centering on the one point VP (see FIG. 13) in the line-of-sight direction is specified as the predetermined range VA. However, a method of specifying the predetermined range is not limited to this and can be variously modified. For example, a region having one point in the line-of-sight direction as one vertex of a rectangular parallelepiped may be specified as the predetermined range. In short, any method may be adopted as long as one point in the line-of-sight direction is included in the predetermined range. The predetermined range goes not always need to be the rectangular parallelepiped and may be other solids (three-dimensional shapes) such as a cube, a sphere, an ellipsoid, a column, and a polygonal prism (a triangular prism, a pentagonal prism, a hexagonal prism, etc.). Further, the predetermined range may be a two-dimensional shape without depth, a circle, and a polygon (a triangle, a pentagon, a hexagon, etc.). The predetermined range does not need to be specified on the basis of the one point in the line-of-sight direction. The predetermined range may be specified on the basis of a part or the entire line-of-sight direction.

### Modification 3

In the embodiments and the modifications, the predetermined range VA is specified on the basis of the line-of-sight direction. However, the predetermined range VA does not always need to be specified on the basis of the line-of-sight direction. Specifically, the predetermined range VA may be specified on the basis of a direction deviating from the line-of-sight direction. The predetermined range VA may be specified on the basis of any direction as long as the direction is a specific direction decided according to the direction of the image display section 20.

### Modification 4

In the embodiments and the modifications, the display system is suitable for the use for supporting the shopping of fruits, golf clubs, and the like. However, the use of the display system is not limited to this and can be variously modified. For example, the use may be a use for borrowing articles and a use for discarding articles. In short, the display system can be applied when a user desires to make some request for articles from the outside of a shopping venue taking into account a state in the shopping venue. Further, a place of shopping is not limited to the shopping venue. The display system can also be applied when a user performs shopping in other places such as a stand and stall. For example, when a friend travels wearing an HMD and performs shopping in a souvenir shop, a stand, a stall, and the like, the invention can be applied assuming that the MMD worn by the friend is the supporter HMD.

### Modification 5

In the embodiments and the modifications, the commodity name, the producing district, the price, the right time for eating, the characteristic, and the like are displayed as the presentation information. However, the presentation information is not limited to these kinds of information and can be variously modified. For example, in the case of foods, a calorie, an ingredient, a content, a unit price per one milliliter, traceability information, and the like may be displayed as the presentation information. Traceability means clarifying processes of cultivation and raising to processing, manufacturing, circulation, and the like in order to secure safety of foods. In the case of clothes and shoes, a size, a color, a stock, a target age group (e.g., married women or young people), and the like may be displayed as the presentation information. In the case of sporting goods, a target skill (e.g., experts, beginners, or ladies) may be added as the presentation information. Position information, store information, settlement information (a point card or a credit card), and the like may be added to the presentation information.

### Modification 6

In the embodiments and the modifications, the image picked up by the camera 61 is transmitted to the supported person HMD 400 after deleting the periphery of the picked-up image to match the picked-up image to the field of view of the supporter. On the other hand, in a picked-up image obtained by deleting the periphery of the picked-up image (a picked-up image for transmission), a portion overlapping the predetermined range VA specified in step S160 may be specified. Processing for increasing brightness may be performed on the specified overlapping portion. An image after the processing may be transmitted to the supported person HMD 400. Note that processing of the image is not limited to the processing for increasing brightness and may be, for example, processing for providing a frame body around the image. With this configuration, it is possible to cause the supported person HMD 400 to display the predetermined range VA in the picked-up image for transmission while highlighting the predetermined range VA compared with other portions.

### Modification 7

In the embodiments and the modifications, the supporter and the supported person respectively wear the HMD 100 and the HMD 400. However, the HMD 400 on the supported person side can also be information processing devices of other types such as a tablet computer, a smartphone, a personal computer, a projector, and a television.

### Modification 8

In the embodiments and the modifications, the short-range wireless communication terminal is the BLE terminal. On the other hand, as a modification, the BLE terminal may be another short-range wireless communication terminal such as a wireless LAN terminal or an infrared communication terminal.

### Modification 9

In the embodiments and the modifications, the wireless communication section 117 includes both of the function of performing wireless communication with the external HMD and the function of performing wireless communication with the BLE terminal functioning as the short-range wireless communication terminal. On the other hand, the functions of the wireless communication section may be performed in separate devices. With this configuration, the separate devices are equivalent to the “wireless communication section” in the first aspect of the invention described in the summary.

### Modification 10

In the embodiments and the modifications, apart of the components realized by hardware may be replaced with software. Conversely, a part of the components realized by software may be replaced with hardware.

### Modification 11

In the second embodiment and the modifications of the second embodiment, the HMD includes the telephotographic camera 710 separately from the camera 61 as the camera for QR code reading. However, the camera 61 may be replaced with a high-performance camera that can move and enlarge a focus area. The reading of the QR code may be performed by the camera 61. Further, a large number of telephotographic cameras may be set in advance in the shopping venue. Picked-up images may be read from the telephotographic cameras by radio and QR codes may be read from the picked-up images.

### Modification 12

In the second embodiment and the modifications of the second embodiment, the telephotographic camera 710 is operated from the supported person HMD 400X side according to the movement of the cursor on the see-through display screen. On the other hand, as a modification, the position of the display screen may be tapped by a fingertip. The “tap” is operation for putting (placing) a fingertip of a hand on an image element and pointing the image element in such a manner as to press the image element. The movement of the fingertip can be detected from picked-up image obtained by controlling a camera to execute image pickup. With this configuration, it is also possible to remotely operate the telephotographic camera 710 from supported person HMD 400X side.

### Modification 13

In the embodiments and the modifications, the supported person wearing the supported person HMD views the presentation information obtained from the BLE terminal and performs the processing for ordering a favorite commodity. On the other hand, the supported person may check a stock of a target commodity from the supported person HMD side before ordering the target commodity. For example, the supported person may ask the supporter HMD with voice such as “do you have a number 5 iron?” or “do you have a number 4 iron?”.

### Modification 14

In the second embodiment and the modifications of the second embodiment, the settlement is performed using the QR code attached to the commodity. On the other hand, as a modification, settlement concerning a commodity may be performed on the supporter side by performing communication between an NFC (Near Field Communication) built in a commodity and the supporter HMD mounted with an NFC.

### Modification 15

In the embodiments, the configuration of the HMD is illustrated. However, the configuration of the HMD can be optionally decided without departing from the spirit of the invention. For example, addition, deletion, conversion, and the like of components can be performed.

In the embodiments, the HMD 100 of a so-called transmission type is explained in which external light is transmitted through the right light guide plate 26 and the left light guide plate 28. However, the invention can also be applied to the HMD 100 of a so-called non-transmission type that displays an image in a state in which an outside scene cannot be transmitted. In these HMDs 100, besides the AR (Augmented Reality) display for displaying an image to be superimposed on the real space explained in the embodiments, MR (Mixed Reality) display for displaying a picked-up image of the real space and a virtual image in combination or VR (Virtual Reality) display for displaying a virtual space can also be performed.

In the embodiment, the functional sections of the control device 10 and the image display section 20 are explained. However, the functional sections can be optionally changed. For example, forms described below may be adopted. A form in which the storing function section 122 and the control function section 150 are mounted on the control device 10 and only a display function is mounted on the image display section 20. A form in which the storing function section 122 and the control function section 150 are mounted on both of the control device 10 and the image display section 20. A form in which the control device 10 and the image display section 20 are integrated. In this case, for example, all of the components of the control device 10 are included in the image display section 20. The image display section 20 is configured as a wearable computer of an eyeglass type. A form in which a smartphone or a portable game machine is used instead of the control device 10. A form in which the control device 10 and the image display section 20 are connected by wireless communication and the connection cable 40 is removed. In this case, for example, power feed to the control device 10 and the image display section 20 may also be carried out by radio.

### Modification 16

In the embodiments, the configuration of the control device is illustrated. However, the configuration of the control device can be optionally decided without departing from the spirit of the invention.

For example, addition, deletion, conversion, and the like of components can be performed.

In the embodiments, an example of the inputting means included in the control device 10 is explained. However, the control device 10 may be configured by omitting an illustrated part of the inputting means. The control device 10 may include other inputting means not explained above. For example, the control device 10 may include an operation stick, a keyboard, and a mouse. For example, the control device 10 may include inputting means for interpreting a command associated with a movement of the body of the user or the like. The movement of the body of the user or the like can be acquired by, for example, line-of-sight detection for detecting a line of sight, gesture detection for detecting a movement of a hand, a footswitch for detecting a movement of a foot, and the like. Note that the line-of-sight detection can be realized by, for example, a camera that performs image pickup on the inner side of the image display section 20. The gesture detection can realized by, for example, analyzing images photographed by the camera 61 over time.

In the embodiments, the control function section 150 operates according to the execution of the computer program in the storing function section 122 by the main processor 140. However, the control function section 150 can adopt various configurations. For example, the computer may be stored in, instead of the storing function section 122 or in addition to the storing function section 122, the nonvolatile storing section 121, the EEPROM 215, the memory 118, and other external storage devices (including storage devices such as USB memories inserted into various interfaces and an external device such as a server connected via a network). The functions of the control function section 150 may be realized using ASICs (Application Specific Integrated Circuits) designed to realize the functions.

### Modification 17

In the embodiments, the configuration of the image display section is illustrated. However, the configuration of the image display section can be optionally decided without departing from the spirit of the invention. For example, addition, deletion, conversion, and the like of components can be performed.

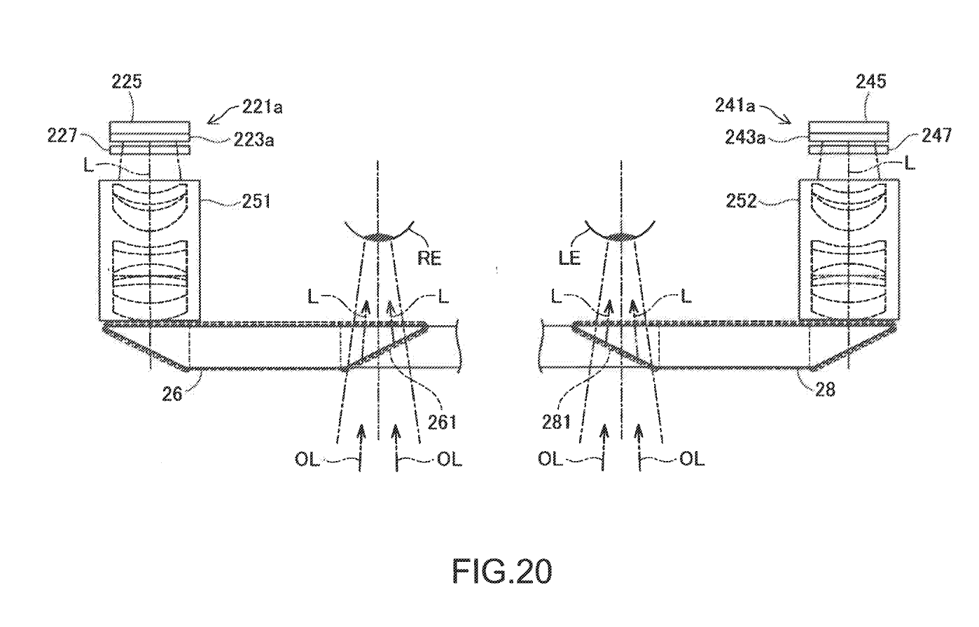

FIG. 20 is a main part plan view showing the configuration of an optical system included in an image display section in a modification. In the image display section in the modification, an OLED unit 221a corresponding to the right eye RE of the user and an OLED unit 214a corresponding to the left eye LE of the user are provided. The OLED unit 221a corresponding to the right eve RE includes an OLED panel 223a that emits white light and the OLED driving circuit 225 that drives the OLED panel 223a to emit light. A modulating element 227 (a modulating device) is disposed between the OLED panel 223a and the right optical system 251. The modulating element 227 is configured by, for example, a transmissive liquid crystal panel and modulates the light emitted by the OLED panel 223a to generate the image light The image light L transmitted through the modulating device 227 to be modulated is guided to the right eye RE by the right light guide plate 26.

The OLED unit 241a corresponding to the left eye LE includes an OLED panel 243a that emits white light and the OLED driving circuit 245 that drives the OLED panel 243a to emit light. A modulating element 247 (a modulating device) is disposed between the OLED panel 243a and the left optical system 252. The modulating element 247 is configured by, for example, a transmissive liquid crystal panel and modulates the light emitted by the OLED panel 243a to generate the image light L. The image light L transmitted through the modulating element 247 to be modulated is guided to the left eye LE by the left light guide plate 28. The modulating elements 227 and 247 are connected to a not-shown liquid crystal driver circuit. The liquid crystal driver circuit (a modulating-device driving section) is mounted on, for example, a substrate disposed near the modulating elements 227 and 247.

In the image display section in the modification, the right display unit 22 and the left display unit 24 are respectively configured as video elements including the OLED panels 223a and 243a functioning as light source sections and the modulating elements 227 and 247 that modulate lights emitted by the light source sections and output image lights including a plurality of color lights. Note that the modulating devices that modulate the lights emitted by the OLED panels 223a and 243a are not limited to the configuration in which the transmissive liquid crystal panel is adopted. example, a reflective liquid crystal panel may be used instead of the transmissive liquid crystal panel. A digital micro-mirror device may be used. The HMD 100 may be the HMD 100 of a laser retinal projection type.

In the embodiment, the image display section 20 of the eyeglass type is explained. However, the form of the image display section 20 can be optionally changed. For example, the image display section 20 may be worn like a cap or may be incorporated in a body protector such as a helmet. The image display section 20 may be configured as a HUD (Head Up Display) mounted on vehicles such as an automobile and an airplane or other transportation means.

In the embodiment, as the optical system that guides the image light to the eyes of the user, the configuration is illustrated in which virtual images are formed by the half mirrors 261 and 281 in parts of the right light guide plate and the left light guide plate 28. However, this configuration can be optionally changed. For example, virtual images may be formed in regions occupying the entire surfaces (or most) of the right light guide plate 26 and the left light guide plate 28. In this case, an image may be reduced by operation for changing a display position of the image. The optical elements according to the invention are not limited to the right light guide plate 26 and the left light guide plate 28 including the half mirrors 261 and 281. Any form can be adopted as long as optical components (e.g., a diffraction grating, a prism, and holography) that make image light incident on the eyes of the user are used.

### Modification 18

The invention is not limited to the embodiments, the examples, and the modifications explained above and can be realized in various configurations without departing from the spirit of the invention. For example, the technical features in the embodiments, the examples, and the modifications corresponding to the technical features in the aspects described in the summary can be substituted or combined as appropriate in order to solve a part or all of the problems explained above or achieve a part or all of the effects explained above. Unless the technical features are explained in this specification as essential features, the technical features can be deleted as appropriate.

The entire disclosure of Japanese Patent Application Nos. 2016-087032, filed Apr. 25, 2016 and 2016-241270, filed Dec. 13, 2016 are expressly incorporated by reference herein.

What is claimed is:

1. A head-mounted display device including an image display section attached to a head, the head-mounted display device comprising:
a specific-direction detecting section configured to detect a specific direction decided according to a direction of the image display section;
a wireless communication section; and
a processing section configured to perform presentation of information to an external inform n processing device via the wireless communication section, wherein
the processing section specifies a predetermined range including the specific direction detected by the specific-direction detecting section, performs communication with a short-range wireless communication terminal present in the specified predetermined range via the wireless communication section, receives data from the short-range wireless communication terminal, and transmits presentation information based on the received data to the information processing device.

2. The head-mounted display device according to claim 1, wherein the specific direction is a direction that the user is viewing.

3. The head-mounted display device according to claim 2, further comprising a camera configured to pick up an image in the direction that the user is viewing, wherein
the processing section transmits at least a part of the image picked up by the camera to the information processing device via the wireless communication section as a picked-up image for transmission.

4. The head-mounted display device according to claim 3, wherein the processing section specifies a portion overlapping the predetermined range in the picked-up image for transmission and performs image processing concerning the overlapping portion.

5. The head-mounted display device according to claim 1, wherein the data received from the short-range wireless communication terminal present in the predetermined range is data for each of types of commodities.

6. The head-mounted display device according to claim 5, wherein the processing section receives, from the external information processing device, an order instruction for a commodity selected out of the commodities, the information of which is presented.

7. The head-mounted display device according to claim 6, wherein the processing section transmits start information for performing settlement processing to the external information processing device and receives, from the external information processing device, the order instruction together with a notification to the effect that the settlement is completed.

8. The head-mounted display device according to claim 1, wherein the external information processing device is another head-mounted display device different from the head-mounted display device.

9. A display system comprising:
a head-mounted display device including an image display section attached to a head; and
an information processing device, wherein
the head-mounted display device includes
a specific-direction detecting section configured to detect a specific direction decided according to a direction of the image display section;
a wireless communication section; and
a processing section configured to perform presentation of information to the information processing device via the wireless communication section,
the processing section specifies a predetermined range including the specific direction detected by the specific-direction detecting section, performs communication with a short-range wireless communication terminal present in the specified predetermined range via the wireless communication section, receives data from the short-range wireless communication terminal, and transmits presentation information based on the received data to the information processing device, and
the information processing device receives the presentation information transmitted from the head-mounted display device and performs display on the basis of the received presentation information.

10. A control method for a head-mounted display device including an image display section attached to a head and including a specific-direction detecting section configured to detect a specific direction decided according to a direction of the image display section and a wireless communication section,
the control method comprising performing presentation of information to an external information processing device via the wireless communication section, wherein
the performing the presentation of information includes:
specifying a predetermined range including the specific direction detected by the specific-direction detecting section;
performing communication with a short-range wireless communication terminal present in the specified predetermined range via the wireless communication section and receiving data from the short-range wireless communication terminal; and
transmitting presentation information based on the received data to the information processing device.

11. A computer program for controlling a head-mounted display device including an image display section attached to a head and including a specific-direction detecting section configured to detect a specific direction decided according to a direction of the image display section and a wireless communication section,
the computer program causing a computer to realize a function of performing presentation of information to an external information processing device via the wireless communication section, wherein
the function includes:
specifying a predetermined range including the specific direction detected by the specific-direction detecting section;
performing communication with a short-range wireless communication terminal present in the specified predetermined range via the wireless communication section and receiving data from the short-range wireless communication terminal; and
transmitting presentation information based on the received data to the information processing device.
